(19) United States
(12) Patent Application Publication
(10) Pub. No.: US 2026/0182792 A1
(43) Pub. Date: Jul. 2, 2026

(54) MOTOR ASSEMBLY, DUST COLLECTION DEVICE, AND CLEANER

(71) Applicant: Samsung Electronics Co., Ltd., Suwon-si (KR)

(72) Inventors: Youngjun CHO, Suwon-si (KR); Ingyu CHOI, Suwon-si (KR); Hyunju LEE, Suwon-si (KR); Dongjin CHO, Suwon-si (KR); Jeongwang CHO, Suwon-si (KR); Seungryong CHA, Suwon-si (KR)

(21) Appl. No.: 19/548,323

(22) Filed: Feb. 24, 2026

Related U.S. Application Data
(63) Continuation of application No. PCT/KR2024/010620, filed on Jul. 23, 2024.

(30) Foreign Application Priority Data
Sep. 11, 2023 (KR) 10-2023-0120491

(51) Int. Cl. A47L 5/28; A47L 9/12; A47L 9/14; H02K 9/26; H02K 11/33; H02K 21/16

(52) U.S. Cl. CPC A47L 5/28; A47L 9/12; A47L 9/14; H02K 9/26; H02K 11/33; H02K 21/16; H02K 2211/03

(57) ABSTRACT

A motor assembly is provided. The motor assembly includes a control board, a fan motor, an impeller that is rotated by the fan motor, a first guide that covers the impeller and guides sucked-in air in an axial direction of the impeller along an air flow path to be directed to the control board, and a second guide disposed between the first guide and the control board to cover the fan motor and guide air along the air flow path, wherein the second guide is located apart from the control board, and wherein the second guide includes a nozzle portion having a gradient of a certain angle with respect to the axial direction at an end facing the control board.

### CROSS-REFERENCE TO RELATED APPLICATION(S)

This application is a continuation application, claiming priority under 35 U.S.C. § 365(c), of an International application No. PCT/KR2024/010620, filed on Jul. 23, 2024, which is based on and claims the benefit of a Korean patent application number 10-2023-0120491, filed on Sep. 11, 2023, in the Ministry of Intellectual Property (MOIP), the disclosure of which is incorporated by reference herein in its entirety.

### BACKGROUND

### 1. Field

The disclosure relates to a motor assembly, a dust collection device, and a cleaner.

### 2. Description of Related Art

A vacuum cleaner, for example, may use negative pressure to suck in air containing foreign substances such as dust.

The vacuum cleaner may include a dust collection device that separates foreign substances from the sucked-in air and stores the separated foreign substances in a dust collector.

The dust collection device may include a motor assembly configured to generate suction force in the vacuum cleaner. The motor assembly may be configured to cause the vacuum cleaner to suck in air containing foreign substances and discharge the air. As the vacuum cleaner is miniaturized, a rotation speed of a motor may increase to prevent a decrease in suction force. Generally, as the rotation speed of the motor increases, a control board that supplies power to the motor may generate excessive heat. Generally, as the rotation speed of the motor increases, noise occurring in the motor assembly may increase. Generally, as the rotation speed of the motor increases, vibration generated from the motor assembly may increase.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a motor assembly, a dust collection device, and a cleaner.

Additional aspects will be set forth in part in the description which follows and, in part, will be apparent from the description, or may be learned by practice of the presented embodiments.

In accordance with an aspect of the disclosure, a motor assembly is provided. The motor assembly includes a control board, a fan motor, an impeller that is rotated by the fan motor, a first guide that covers the impeller and guides sucked-in air in an axial direction of the impeller along an air flow path to be directed to the control board, and a second guide disposed between the first guide and the control board to cover the fan motor and guide air along the air flow path, wherein the second guide is located apart from the control board, and wherein the second guide includes a nozzle portion having a gradient of a certain angle with respect to the axial direction at an end facing the control board.

In accordance with another aspect of the disclosure, a dust collection device configured to generate suction force in a vacuum cleaner and temporarily store foreign substances sucked in by the vacuum cleaner is provided. The dust collection device includes a motor portion including a motor assembly, and a dust collector configured to separate foreign substances from air sucked in by the vacuum cleaner and temporarily store the foreign substances, wherein the motor assembly includes a control board, a fan motor, an impeller that is rotated by the fan motor, a first guide that covers the impeller and guides sucked-in air in an axial direction of the impeller along an air flow path to be directed to the control board, and a second guide disposed between the first guide and the control board to cover the fan motor and guide air along the air flow path, wherein the second guide is located apart from the control board, and wherein the second guide includes a nozzle portion having a gradient of a certain angle with respect to the axial direction at an end facing the control board.

In accordance with another aspect of the disclosure, a vacuum cleaner is provided. The vacuum cleaner includes a suction device configured to suck in foreign substances, a vacuum cleaner body including a dust collection device configured to store foreign substances sucked in through the suction device, and a transfer portion disposed between the suction device and the vacuum cleaner body and configured to transfer sucked-in foreign substances from the suction device to the vacuum cleaner body, wherein the dust collection device includes a motor portion including a motor assembly, and a dust collector configured to separate foreign substances from air sucked in by the vacuum cleaner and temporarily store the foreign substances, wherein the motor assembly includes a control board, a fan motor, an impeller that is rotated by the fan motor, a first guide that covers the impeller and guides sucked-in air in an axial direction of the impeller along an air flow path to be directed to the control board, and a second guide disposed between the first guide and the control board to cover the fan motor and guide air along the air flow path, wherein the second guide is located apart from the control board, and wherein the second guide includes a nozzle portion having a gradient of a certain angle with respect to the axial direction at an end facing the control board.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a vacuum cleaner according to an embodiment of the disclosure;

FIG. 2 is a perspective view of a vacuum cleaner body according to an embodiment of the disclosure;

FIG. 3 is an exploded perspective view of a vacuum cleaner body according to an embodiment of the disclosure;

FIG. 4 is a perspective view of a dust collection device with an open discharge cap, according to an embodiment of the disclosure;

FIG. 5 is a perspective view showing connection between a dust collector and a motor portion of a dust collection device, according to an embodiment of the disclosure;

FIG. 6 is a perspective view of a motor portion according to an embodiment of the disclosure;

FIG. 7 is an exploded perspective view showing a housing separated from a motor portion, according to an embodiment of the disclosure;

FIG. 8 is an exploded perspective view illustrating a filter further separated from a motor assembly of FIG. 7, according to an embodiment of the disclosure;

FIG. 9 is an exploded perspective view showing a filter support further separated from the motor assembly of FIG. 8 according to an embodiment of the disclosure;

FIG. 10 is an exploded perspective view showing a support frame further separated from the motor assembly of FIG. 9 according to an embodiment of the disclosure;

FIG. 11 is an exploded perspective view showing separation of a filter assembly according to an embodiment of the disclosure;

FIG. 12 is a perspective view of a motor assembly viewed from a different angle, according to an embodiment of the disclosure;

FIG. 13 is an exploded perspective view showing a guide cover separated from the motor assembly of FIG. 11, according to an embodiment of the disclosure;

FIG. 14 is a cross-sectional perspective view of a cross section of the motor assembly of FIG. 12 according to an embodiment of the disclosure;

FIG. 15 is an exploded perspective view of a state in which a first guide and a second guide are separated from the motor assembly of FIG. 12 viewed from a different direction, according to an embodiment of the disclosure;

FIG. 16 is a perspective view illustrating an operation of a clip portion of a second guide, according to an embodiment of the disclosure;

FIG. 17 is a partial cross-sectional view of a second guide according to an embodiment of the disclosure;

FIG. 18 is a cross-sectional view of the motor portion of FIG. 6 viewed in a direction B-B, according to an embodiment of the disclosure;

FIG. 19 is a cross-sectional view of the motor portion of FIG. 6 viewed in a direction C-C, according to an embodiment of the disclosure; and

FIG. 20 is a diagram for explaining noise of a motor assembly according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

With regard to a description of drawings, similar reference numerals may be used for similar or related components.

In this document, each of the phrases “A or B”, “at least one of A and B”, “at least one of A or B”, “A, B, or C”, “at least one of A, B, and C”, and “at least one of A, B, or C” may include any one of the items listed together in the phrase, or all possible combinations thereof.

The term “and/or” includes any combination of a plurality of related described components or any one of the plurality of related described components.

The terms such as “1st”, “2nd”, or “first” or “second” may be used merely to distinguish one component from another, and do not limit the components in any other aspect (e.g., importance or order).

When a component (e.g., a first component) is referred to as being “coupled” or “connected” to another component (e.g., a second component), with or without the terms “functionally” or “communicatively,” it means that the component may be connected to the other component directly (e.g., wired), wirelessly, or through a third component.

The terms “comprise (include)” or “have” are intended to specify the presence of a feature, number, step, operation, component, part, or combination thereof described in this document, but do not exclude the presence or addition of one or more other features, numbers, steps, operations, components, parts, or combinations thereof.

When a component is said to be “connected,” “coupled,” “supported,” or “in contact with” another component, this includes not only a case in which the components are directly connected, coupled, supported, or in contact, but also a case in which the components are indirectly connected, coupled, supported, or in contact through a third component.

When a component is said to be “on” another component, this includes not only a case in which the component is in contact with the other component, but also a case in which there is another component between the two components.

A vacuum cleaner, for example, may suck in foreign substances such as dust along with the air by using the suction force generated by a suction fan, filter out the foreign substances, and store the foreign substances in a dust collector.

Hereinafter, example embodiments according to the disclosure will be described in detail with reference to the contents described in the attached drawings. The same reference numbers or symbols presented in each drawing represent parts or components that perform substantially the same functions.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

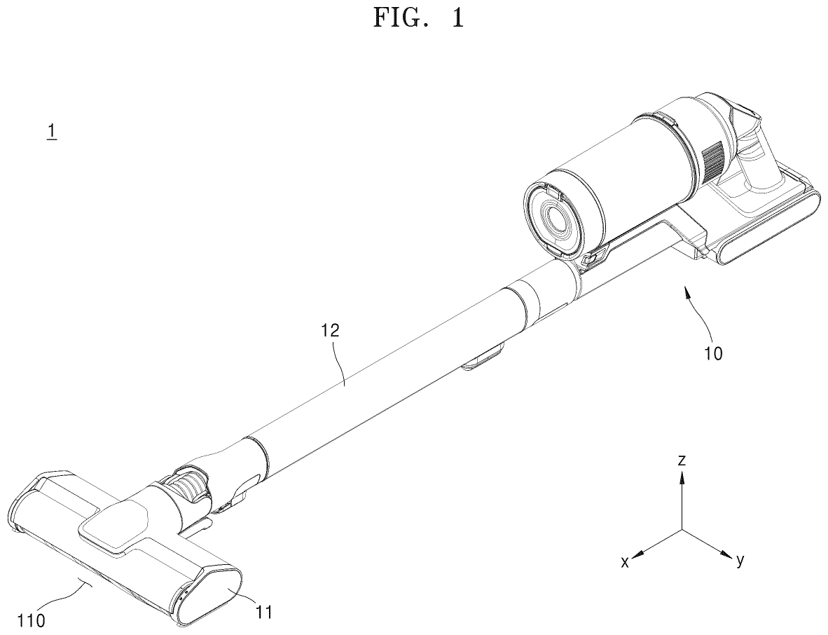

FIG. 1 is a perspective view of a vacuum cleaner according to an embodiment of the disclosure.

Referring to FIG. 1, a vacuum cleaner 1 according to an example embodiment may include a vacuum cleaner body 10, a suction device 11, and a transfer portion 12. The vacuum cleaner body 10 may provide suction force to the vacuum cleaner 1. The vacuum cleaner body 10 may provide suction force to the vacuum cleaner 1. The vacuum cleaner body 10 may generate suction force in the vacuum cleaner 1. The vacuum cleaner body 10 may provide suction force to the suction device 11. The vacuum cleaner body 10 may generate suction force in the suction device 11. The vacuum cleaner body 10 may be connected to the suction device 11 through the transfer portion 12. The transfer portion 12 may be located between the suction device 11 and the vacuum cleaner body 10. The transfer portion 12 may connect the vacuum cleaner 1 to the suction device 11. The transfer portion 12 may transfer the suction force provided by the vacuum cleaner body 10 to the suction device 11.

The suction device 11 according to an example embodiment may include a first suction portion 110. The suction device 11 may suck in air through the first suction portion 110. The suction device 11 may be configured to suck in foreign substances through the first suction portion 110. The suction device 11 may transfer sucked-in air from the first suction portion 110 to the vacuum cleaner body 10. The suction device 11 may transfer sucked-in foreign substances from the first suction portion 110 to the vacuum cleaner body 10. The suction device 11 may be located on a surface on which an object to be cleaned is located. The object to be cleaned may be a surface of the floor. The suction device 11 may not transfer foreign substances having a certain size or larger to the vacuum cleaner body 10. However, the arrangement and function of the suction device 11 are not limited to the above description.

The transfer portion 12 according to an example embodiment may transfer air sucked in by the suction device 11 to the vacuum cleaner body 10. The transfer portion 12 may transfer sucked-in foreign substances from the suction device 11 to the vacuum cleaner body 10. The transfer portion 12 may extend in a direction parallel to the x-axis. The transfer portion 12 may extend in a first direction. The transfer portion 12 may extend a long way. A length by which the transfer portion 12 extends may be a length that allows the suction device 11 to be positioned on a surface on which the object to be cleaned is located when a user holds the vacuum cleaner body 10 in an upright position. The vacuum cleaner 1 may be a stick-type vacuum cleaner 1. The user may clean a surface of the object to be cleaned in an upright position by using the vacuum cleaner 1. However, the functions of the transfer portion 12 and the vacuum cleaner 1 are not limited to the above description. The shape and whether the transfer portion 12 are required are not limited to the above description. For example, the vacuum cleaner 1 according to an example embodiment may not include the transfer portion 12.

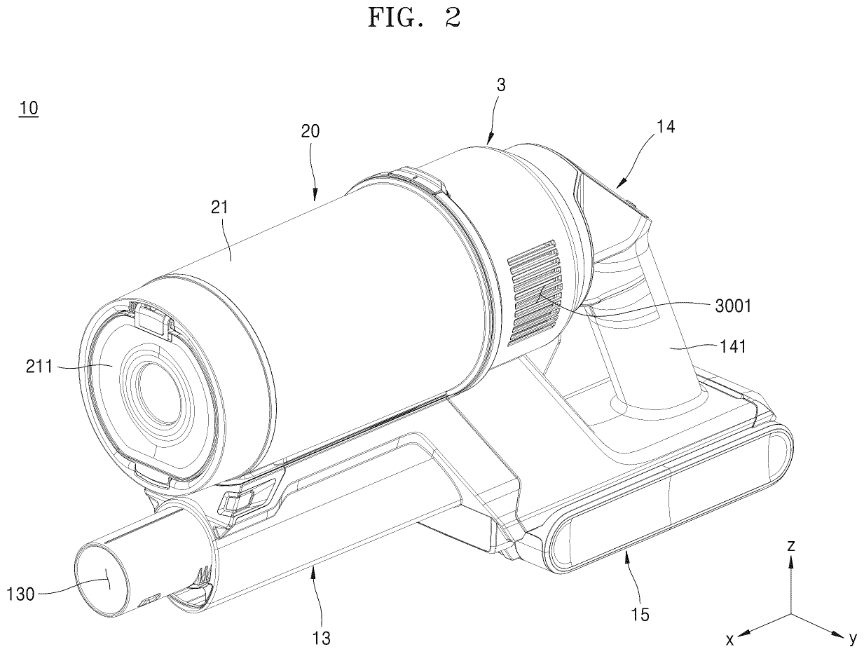

FIG. 2 is a perspective view of a vacuum cleaner body according to an embodiment of the disclosure.

Referring to FIGS. 1 and 2, a vacuum cleaner body 10 according to an example embodiment may include a connector 13. The connector 13 may be connected to the transfer portion 12. The connector 13 may provide suction force to the suction device 11. The connector 13 may generate suction force in the suction device 11. The connector 13 may include a second suction portion 130. The second suction portion 130 may suck in air. The second suction portion 130 may be connected to the first suction portion 110. The second suction portion 130 may suck in foreign substances. The second suction portion 130 may transfer foreign substances to a dust collection device 20. However, the function and role of the configuration of the connector 13 are not limited to the above description.

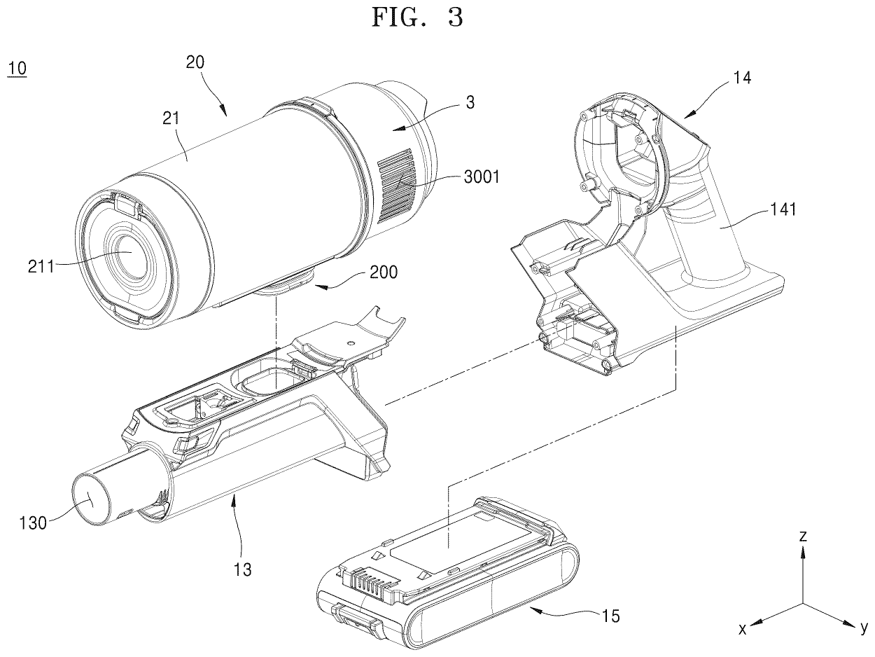

FIG. 3 is an exploded perspective view of a vacuum cleaner body according to an embodiment of the disclosure.

Referring to FIGS. 1 to 3, a vacuum cleaner body 10 according to an example embodiment may include a dust collection device 20. The dust collection device 20 may suck in air. The dust collection device 20 may suck in foreign substances. The dust collection device 20 may provide suction force to the vacuum cleaner body 10. The dust collection device 20 may generate suction force in the vacuum cleaner body 10. The dust collection device 20 may provide suction force to the connector 13. The dust collection device 20 may include a third suction portion 200. The third suction portion 200 may suck in foreign substances. The third suction portion 200 may be connected to the second suction portion 130. The third suction portion 200 may be coupled to the connector 13. The connector 13 may connect the third suction portion 200 to the first suction portion 110. The dust collection device 20 may include a discharge portion 3001. The discharge portion 3001 may discharge the air sucked in by the dust collection device 20. The dust collection device 20 may be configured to suck in air through the third suction portion and discharge the air through the discharge portion 3001.

The dust collection device 20 according to an example embodiment may be a cyclone-type dust collection device 20. The vacuum cleaner 1 may be a cyclone-type vacuum cleaner 1. However, the types of dust collection device 20 and vacuum cleaner 1 are not limited to the above description.

The dust collection device 20 according to an example embodiment may include a dust collector 21. The dust collector 21 may store foreign substances sucked in by the dust collection device 20. The dust collector 21 may temporarily store foreign substances. A method by which the dust collector 21 stores foreign substances may utilize the cyclone principle. However, the function and principle of the dust collector 21 are not limited to the above description.

The vacuum cleaner body 10 according to an example embodiment may include a manipulator 14. The user may manipulate the vacuum cleaner body 10 through the manipulator 14. The manipulator 14 may be electrically connected to the dust collection device 20. The manipulator 14 may include a handle 141. The handle 141 may be a portion through which the user holds the vacuum cleaner body 10. However, the function of the manipulator 14 is not limited to the above description.

The vacuum cleaner body 10 according to an example embodiment may include a battery portion 15. The battery portion 15 may supply power to the manipulator 14. The battery portion 15 may supply power to the dust collection device 20 through the manipulator 14. The battery portion 15 may be located below the manipulator 14. However, the function and arrangement of the battery portion 15 are not limited to the above description.

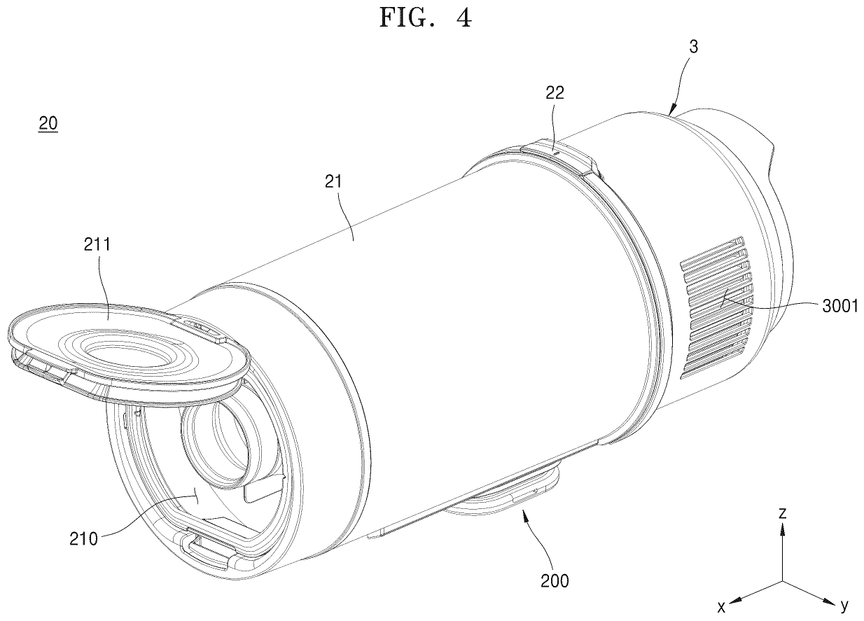

FIG. 4 is a perspective view of a dust collection device with an open discharge cap according to an embodiment of the disclosure.

Referring to FIG. 4, a dust collection device 20 according to an example embodiment may include a storage portion 210. The dust collector 21 may include the storage portion 210 configured to store foreign substances therein. The storage portion 210 may store foreign substances sucked in by the dust collection device 20. The storage portion 210 may temporarily store foreign substances. The foreign substances sucked in by the dust collection device 20 may be stored in the storage portion 210 inside the dust collector 21. However, the function of the storage portion 210 is not limited to the above description.

The dust collection device 20 according to an example embodiment may include a discharge cap 211. The dust collector 21 may include the discharge cap 211. The discharge cap 211 may be located at one side surface of the dust collector 21. The dust collector 21 may open the discharge cap 211. The dust collector 21 may open the discharge cap 211 to expose the storage portion 210 inside the dust collector 21 to the outside. The user may open the discharge cap 211 to discharge foreign substances temporarily stored in the dust collector 21 to the outside. However, the function and arrangement of the discharge cap 211 are not limited to the above description.

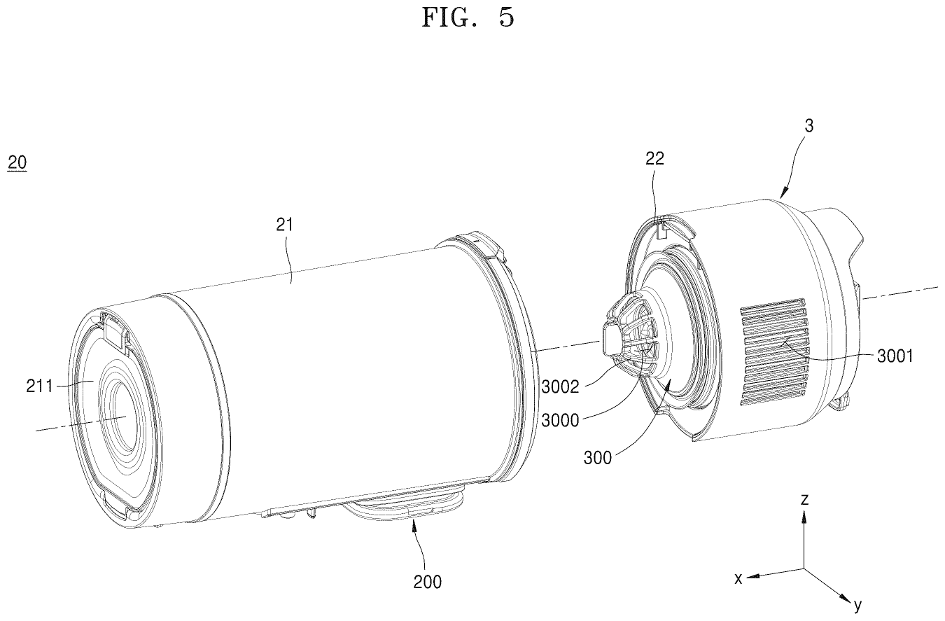

FIG. 5 is a perspective view showing connection between a dust collector and a motor portion of a dust collection device according to an embodiment of the disclosure.

Referring to FIG. 5, a dust collection device 20 according to an example embodiment may include a motor portion 3. The motor portion 3 may provide suction force to the dust collection device 20. The motor portion 3 may generate suction force in the dust collection device 20. The motor portion 3 may provide suction force to a dust collector 21. The motor portion 3 may generate suction force in the dust collector 21.

The motor portion 3 according to an example embodiment may include a fourth suction portion 3000. The motor portion 3 may generate suction force through the fourth suction portion 3000. The motor portion 3 may provide suction force through the fourth suction portion 3000. The motor portion 3 may suck in air through the fourth suction portion 3000 and discharge the air through the discharge portion 3001.

The dust collector 21 and the motor portion 3 according to an example embodiment may be connected to each other in the x-axis direction. The dust collector 21 and the motor portion 3 may be connected to each other in the first direction. The connection between the dust collector 21 and the motor portion 3 may mean that an air flow path formed inside the dust collector 21 and an air flow path formed inside the motor portion 3 are connected to each other.

The dust collector 21 according to an example embodiment may be separated through a separation manipulator 22. However, a method by which the motor portion 3 and the dust collector 21 are separated is not limited to the above description.

Referring back to FIGS. 4 and 5, the dust collector 21 according to an example embodiment may separate and store foreign substances inside the air sucked in by the third suction portion 200. The dust collector 21 may collect the foreign substances in the air sucked in by the third suction portion 200. The dust collector 21 may remove the foreign substances inside the air sucked in by the third suction portion 200 and transfer the foreign substances to the motor portion 3. The motor portion 3 may receive, from the dust collector 21, air from which foreign substances have been removed. Internal foreign substances may be removed before the air sucked in by the dust collection device 20 moves from the dust collector 21 to the motor portion 3. The internal foreign substances may be separated before the air sucked in by the dust collection device 20 moves from the dust collector 21 to the motor portion 3. The dust collection device 20 may separate the foreign substances contained in the air in a cyclone manner. The removal of foreign substances inside the air may mean that foreign substances are temporarily stored in the storage portion 210 included in the dust collector 21. The motor portion 3 may generate suction force such that the dust collector 21 sucks in air and stores foreign substances. However, the relationship between the motor portion 3 and the dust collector 21 is not limited to the above description.

The sizes of the vacuum cleaner 1 and dust collection device 20 and the performance of the motor portion 3 will be described below.

Referring back to FIGS. 1, 4 and 5, the dust collection device 20 according to an example embodiment may be a small-sized dust collection device 20. The vacuum cleaner 1 may be a small-sized vacuum cleaner 1. The small-sized vacuum cleaner 1 may be the vacuum cleaner 1 including the small-sized dust collection device 20. The small-sized dust collection device 20 may be the dust collection device 20 with a reduced diameter compared to existing ones. The small-sized vacuum cleaner 1 may be the vacuum cleaner 1 including the small-sized dust collection device 20. The small-sized vacuum cleaner 1 may be the vacuum cleaner 1 including the small-sized transfer portion 12. The small-sized dust collection device 20 may be the dust collection device 20 including the dust collector 21 with a reduced diameter. The small-sized dust collection device 20 may be a dust collection device with a reduced diameter of the motor portion 3. The small-sized transfer portion 12 may be the transfer portion 12 with a reduced diameter. The diameter of the dust collection device 20 and the diameter of the motor portion 3 may be the same. The diameter may be the diameter of a cross section perpendicular to the extension direction. The diameter may be the diameter of a cross section perpendicular to the x-axis direction. The diameter may be the diameter of a cross section perpendicular to the first direction. The diameter of the small-sized dust collection device 20 may be 80 millimeters (mm) or more and 110 mm or less. The diameter of the small-sized dust collection device 20 may be 90 mm or more and 100 mm or less. The diameter of the small-sized dust collection device 20 may be about 94 mm. However, the sizes of dust collection device 20 and vacuum cleaner 1 are not limited to the above description.

The motor portion 3 of the dust collection device 20 according to an example embodiment may be a high-performance motor portion 3. The high-performance motor portion 3 may provide strong suction force. When the motor portion 3 is the high-performance motor portion 3, if the dust collection device 20 is the small-sized dust collection device 20, the suction force may be prevented from decreasing. When the motor portion 3 is the high-performance motor portion 3, if the vacuum cleaner 1 is the small-sized vacuum cleaner 1, the suction force may be prevented from decreasing. However, the performance and role of the motor portion 3 are not limited to the above description.

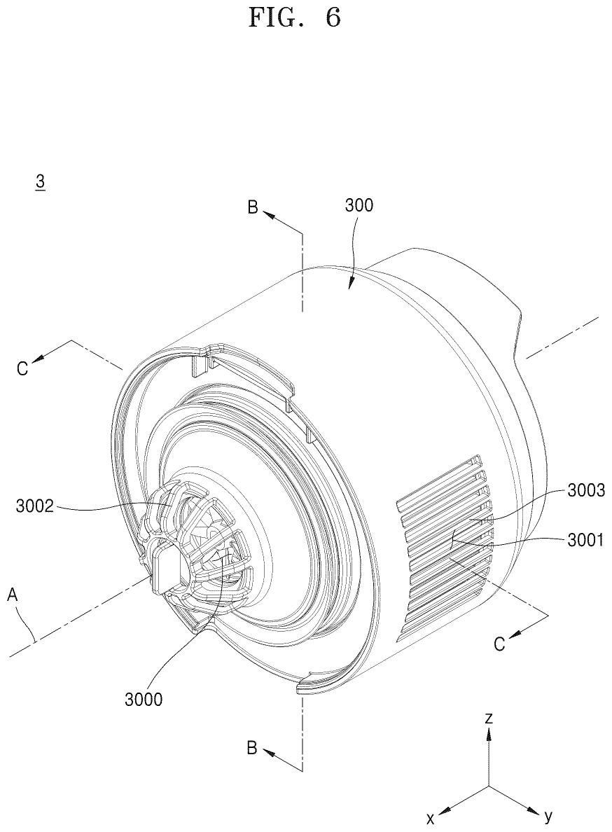

FIG. 6 is a perspective view of the motor portion according to an embodiment of the disclosure.

Referring to FIG. 6, a motor portion 3 according to an example embodiment may include a first grill 3002 covering a fourth suction portion 3000. The first grill 3002 may protect the fourth suction portion 3000. However, the function of the first grill 3002 is not limited to the above description.

The motor portion 3 according to an example embodiment may include a second grill 3003 covering the discharge portion 3001. The second grill 3003 may protect the discharge portion 3001. However, the function of the second grill 3003 is not limited to the above description.

According to an example embodiment, the motor portion 3 may be located around an axial direction A. The axial direction A may be a direction parallel to the x-axis. The axial direction A may be a direction parallel to the first direction. The axial direction A may be a direction in which the motor portion 3 sucks in air. However, a detailed direction of the axial direction A is not limited to the above description.

The fourth suction portion 3000 according to an example embodiment may be located in the axial direction A. The discharge portion 3001 may not be located in the axial direction A. The discharge portion 3001 may be located in a radial direction that intersects with the axial direction A. The discharge portion 3001 may be located in a second direction that intersects with the first direction. The second direction may be parallel to the y-axis. However, the arrangement relationship between the fourth suction portion 3000 and the discharge portion 3001 is not limited to the above description.

According to an example embodiment, the discharge portion 3001 may be provided in a plural number. The plurality of discharge portions 3001 may be arranged to face each other in the second direction. However, the number and arrangement of the discharge portion 3001 are not limited to the above description.

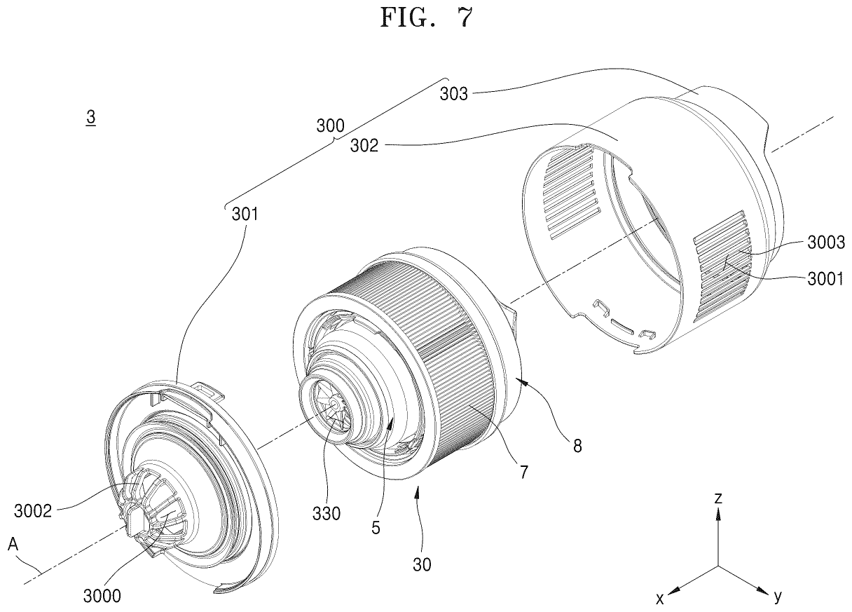

FIG. 7 is an exploded perspective view showing a housing separated from a motor portion according to an embodiment of the disclosure.

Referring to FIGS. 6 and 7, a motor portion 3 according to an example embodiment may include a housing 300 and a motor assembly 30. The housing 300 may constitute an outer appearance of the motor portion 3. The housing 300 may cover the motor assembly 30. The housing 300 may constitute an outer appearance of the motor assembly 30. The housing 300 may support the motor assembly 30. The housing 300 may include the fourth suction portion 3000 and the discharge portion 3001.

The motor assembly 30 according to an example embodiment may provide suction force to the motor portion 3. The motor assembly 30 may generate suction force in the motor portion 3. The motor assembly 30 may provide suction force to the fourth suction portion 3000. The motor portion 3 may generate suction force in the fourth suction portion 3000.

The motor assembly 30 according to an example embodiment may include a fifth suction portion 330. The fifth suction portion may be disposed in the axial direction A. The fifth suction portion 330 may be located in the first direction. The motor assembly 30 may generate suction force through the fifth suction portion 330. The motor assembly 30 may provide suction force through the fifth suction portion 330. The motor assembly 30 may discharge the sucked-in air in a radial direction that intersects with the axial direction A. The motor assembly 30 may discharge the sucked-in air in a second direction that intersects with the first direction. However, a direction in which the motor assembly 30 sucks in and discharges air is not limited to the above description.

The motor assembly 30 according to an example embodiment may include a filter 7. The filter 7 may be configured to collect air discharged by the motor assembly 30. The filter 7 may be configured to collect foreign substances discharged to the discharge portion 3001. The filter 7 may cover the motor assembly 30 in a radial direction. The filter 7 may cover the motor assembly 30 from the outside around the axial direction A. The filter 7 may collect foreign substances contained in the air discharged from the motor assembly 30. The air sucked in by the motor assembly 30 may pass through the filter 7 when discharged. The foreign substances contained in the air discharged by the motor assembly 30 may be collected by the filter 7. However, the function of the filter 7 is not limited to the above description.

An upper housing 301 included in the housing 300 according to an example embodiment may be located to face the fifth suction portion 330. The upper housing 301 may include the fourth suction portion 3000. The fourth suction portion 3000 may be located to face the fifth suction portion 330. The upper housing 301 may cover an upper portion of the motor assembly 30. The upper housing 301 may protect an upper portion of the motor assembly 30. The upper portion of the motor assembly 30 may be at a position in a direction in which the fifth suction portion is located. However, the function and arrangement of the upper housing 301 are not limited to the above description.

A lower housing 303 provided in the housing 300 according to an example embodiment may be located to face the upper housing 301. The lower housing 303 may cover a lower portion of the motor assembly 30. However, the function and arrangement of the lower housing 303 are not limited to the above description.

A side housing 302 provided in the housing 300 according to an example embodiment may connect the upper housing 301 to the lower housing 303. The side housing 302 may cover the filter 7. The side housing 302 may cover a side portion of the motor assembly 30. The side housing 302 may cover the motor assembly 30 in a radial direction. However, the function and arrangement of the side housing 302 are not limited to the above description.

The side housing 302 according to an example embodiment may include the discharge portion 3001. The side housing 302 may cover the motor assembly 30 in a radial direction. The side housing 302 may cover the motor assembly 30 from the outside around the axial direction A. The air discharged from the motor assembly 30 may pass through the filter 7 and be discharged to the discharge portion 3001 of the side housing 302. The air discharged from the motor assembly 30 may move along an inner wall of the side housing 302. The air discharged from the motor assembly 30 may move along the inner wall of the side housing 302 toward the discharge portion 3001. The side housing 302 may provide an air flow path such that air discharged from the motor assembly 30 is discharged to the discharge portion 3001. However, the function and arrangement of the side housing 302 are not limited to the above description.

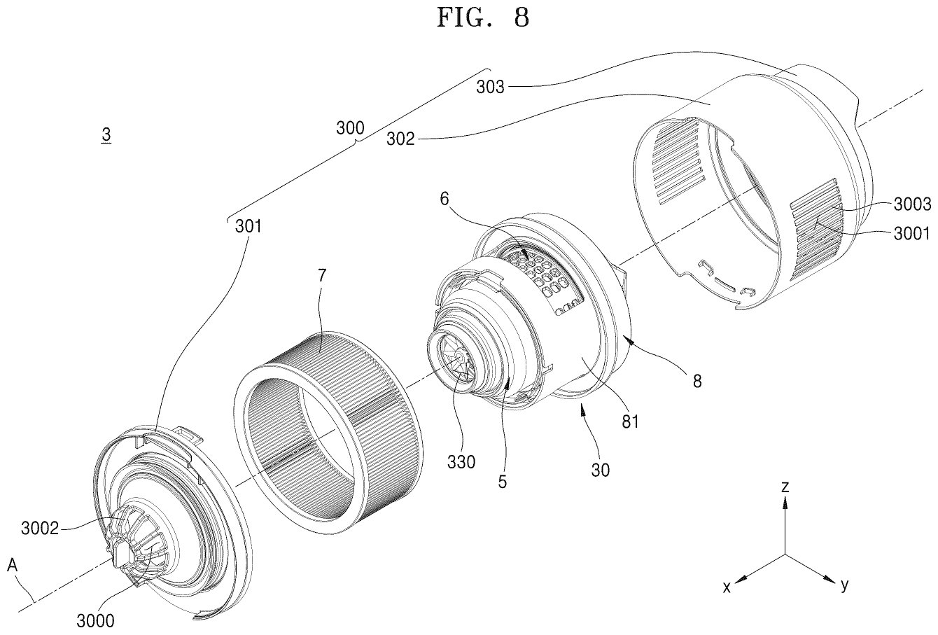

FIG. 8 is an exploded perspective view illustrating a filter further separated from the motor assembly of FIG. 7 according to an embodiment of the disclosure.

Referring to FIGS. 7 and 8, a motor assembly 30 according to an example embodiment may include a filter support 8 disposed inside a filter 7. The filter support 8 may support the filter 7 within the filter 7. The filter support 8 may be located to support the filter 7 between the filter 7 and a support frame 6. However, the function and arrangement of the filter support 8 are not limited to the above description.

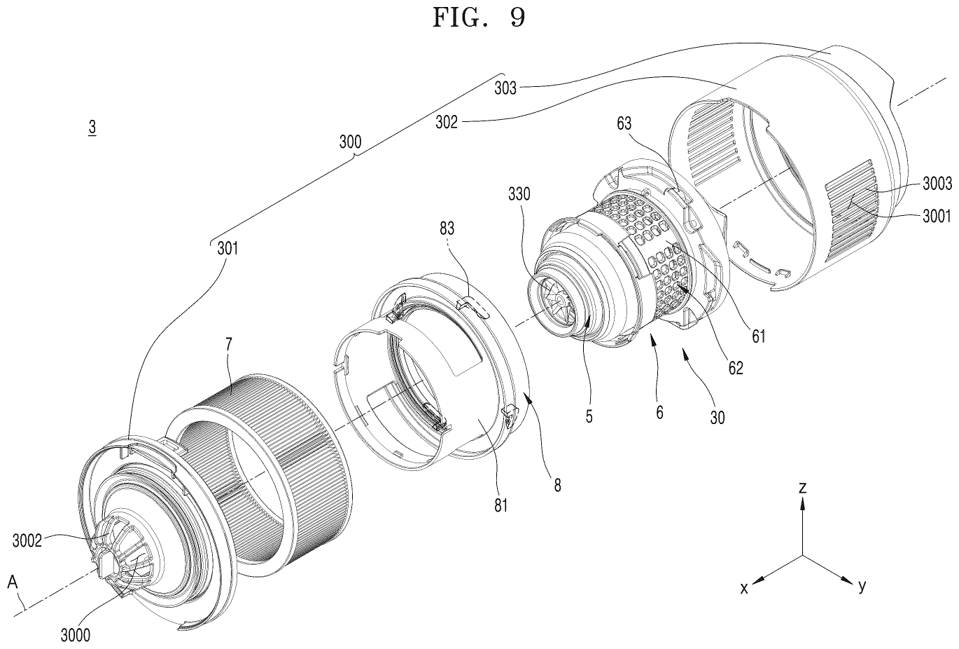

FIG. 9 is an exploded perspective view showing a filter support further separated from the motor assembly of FIG. 8 according to an embodiment of the disclosure.

Referring to FIG. 9, a motor assembly 30 according to an example embodiment may include a support frame 6. The support frame 6 may cover the motor assembly 30 in a radial direction. The support frame 6 may cover the motor assembly 30 from the outside around the axial direction A.

The motor assembly 30 according to an example embodiment may discharge the sucked-in air through the support frame 6. The filter 7 may be located between the support frame 6 and the housing 300. Air discharged through the support frame 6 may pass through the filter 7 and be discharged to the discharge portion 3001 of the housing 300.

The support frame 6 according to an example embodiment may include a plurality of discharge holes 62 arranged along an outer circumferential surface 61. The plurality of discharge holes 62 may be disposed in the radial direction of the motor assembly 30. The plurality of discharge holes 62 may be disposed in a direction toward the side surface of the motor assembly 30. However, the arrangement of the discharge holes 62 is not limited to the above description.

The discharge hole 62 according to an example embodiment may provide a flow path for the air discharged by the motor assembly 30. The discharge hole 62 may be a passage through which the air discharged from the motor assembly 30 is discharged. The air discharged from the motor assembly 30 may be discharged through the discharge hole 62. However, the function of the discharge hole 62 is not limited to the above description.

The performance and noise prevention of the motor assembly 30 will be described below.

Referring back to FIGS. 7 to 9, the motor assembly 30 of the motor portion 3 according to an example embodiment may be the high-performance motor assembly 30. The high-performance motor assembly 30 may provide strong suction force. When the motor assembly 30 is the high-performance motor assembly 30, noise prevention may be required. However, the performance and noise occurrence of the motor assembly 30 are not limited to the above description.

The noise of the motor assembly 30 according to an example embodiment may transferred to the outside through the plurality of discharge holes 62. The noise of the motor assembly 30 may be transferred to the outside through the air discharged through the plurality of discharge holes 62.

The plurality of discharge holes 62 according to an example embodiment may be arranged radially. The plurality of discharge holes 62 may be arranged radially with respect to the axial direction A. The lengths of the flow paths through which the air discharged from the plurality of discharge holes 62 is discharged to the discharge portion 3001 may be different from each other.

Among the plurality of discharge holes 62 according to an example embodiment, there may be the discharge hole 62 located to face the discharge portion 3001. Among the plurality of discharge holes 62, the discharge hole 62 located to face the discharge portion 3001 may be adjacent to the discharge portion 3001. Among the plurality of discharge holes 62, the discharge hole 62 located to face the discharge portion 3001 may overlap the discharge portion 3001.

The filter support 8 according to an example embodiment may include a barrier 81. The barrier 81 may cover, from the outside, the discharge hole 62 that is from among the plurality of discharge holes 62 and located to face the discharge portion 3001. The barrier 81 may block a space between the discharge portion 3001 and the discharge hole 62 located to face the discharge portion 3001 among the plurality of discharge holes 62. The barrier 81 may prevent air discharged from the discharge hole 62 located to face the discharge portion 3001 from being discharged directly to the discharge portion 3001. The barrier 81 may prevent noise passing through the discharge hole 62 located to face the discharge portion 3001 from being discharged directly to the discharge portion 3001.

The barrier 81 may provide a bypass flow path for air discharged from the discharge hole 62 located to face the discharge portion 3001. The barrier 81 may provide a bypass path for noise passing through the discharge hole 62 located to face the discharge portion 3001. The air discharged from the discharge hole 62 located to face the discharge portion 3001 may bypass the barrier 81 before being discharged to the discharge portion 3001. Noise passing through the discharge hole 62 located to face the discharge portion 3001 may bypass the barrier 81 before being discharged to the discharge portion 3001.

The barrier 81 may prevent noise occurring in the motor assembly 30 from being directly discharged to the discharge portion 3001. When the noise discharged by the motor assembly 30 is bypassed through the barrier 81, the noise may be reduced. The barrier 81 may reduce noise occurring in the motor assembly 30. However, the arrangement and function of the barrier 81 are not limited to the above description.

The barrier 81 according to an example embodiment may be located at a certain interval from the discharge hole 62. When the barrier 81 is located at a certain interval from the discharge hole 62, the barrier 81 may not block a flow path of air discharged from the discharge hole 62. The interval between the barrier 81 and the discharge hole 62 may be 4 mm or more and 6 mm or less. However, the distance relationship between the barrier 81 and the discharge hole 62 is not limited to the above description.

Referring back to FIGS. 8 and 9, the filter support 8 according to an example embodiment may be coupled to the support frame 6. The filter support 8 may be supported on the support frame 6. At least one fifth protrusion 83 may be located on one of the filter support 8 and the support frame 6, and at least one fifth groove 63 may be located on the other of the filter support 8 and the support frame 6. The filter support 8 may include the fifth protrusion 83. The support frame 6 may include the fifth groove 63. The fifth protrusion 83 of the filter support 8 may be coupled to the fifth groove 63 of the support frame 6. However, the coupling relationship between the filter support 8 and the support frame 6 is not limited to the above description.

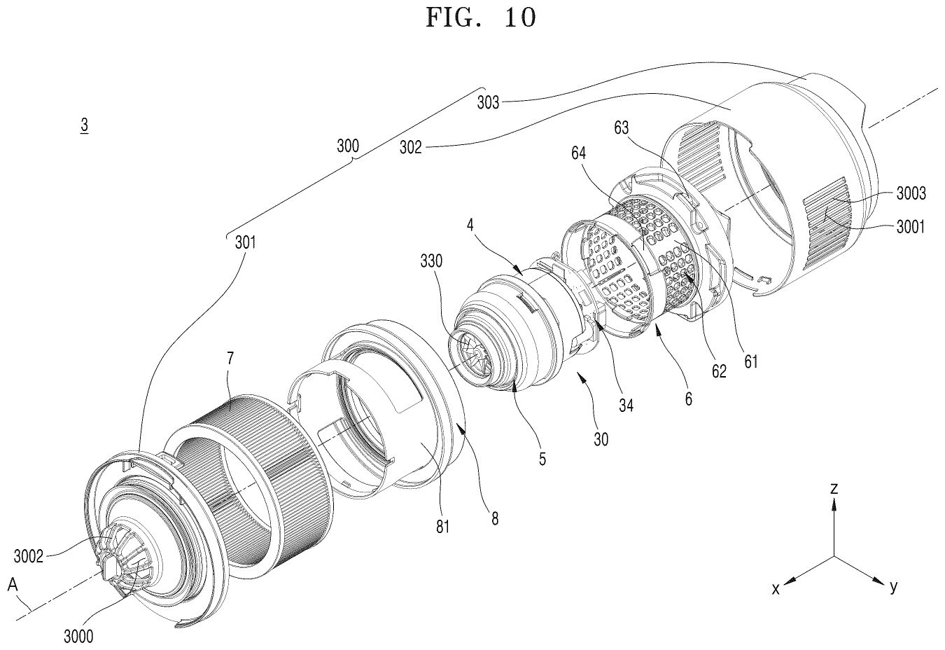

FIG. 10 is an exploded perspective view showing a support frame further separated from the motor assembly of FIG. 9 according to an embodiment of the disclosure.

Referring to FIG. 10, a support frame 6 according to an example embodiment may support a motor assembly 30 from the outside of the motor assembly 30. The motor assembly 30 may be fixed to the support frame 6. The support frame 6 may be fixed to the housing 300. The support frame 6 may be fixed to the lower housing 303. However, the function of the support frame 6 is not limited to the above description.

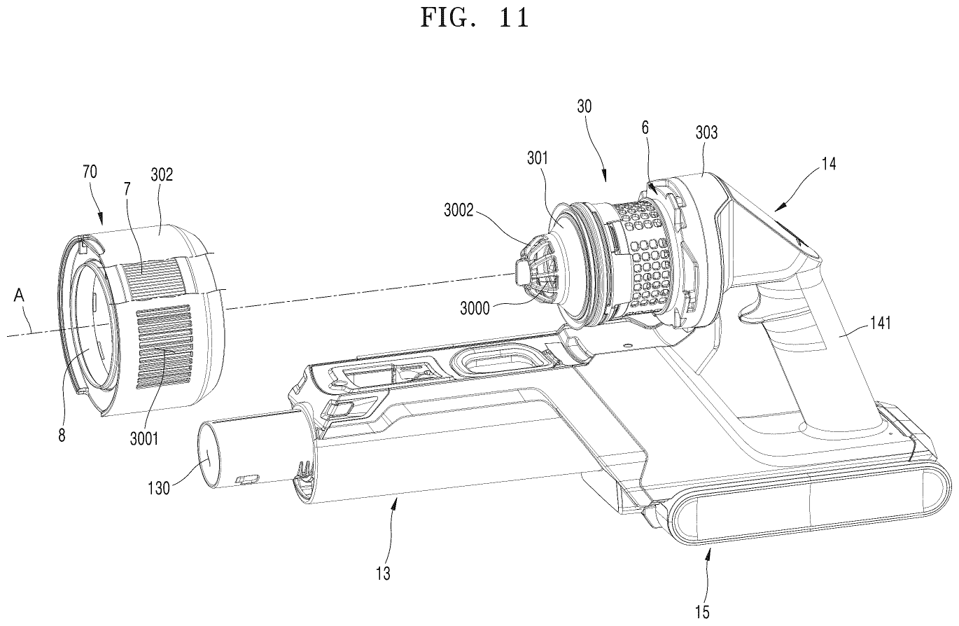

FIG. 11 is an exploded perspective view showing separation of a filter assembly according to an embodiment of the disclosure.

Referring to FIGS. 7 to 11, a filter assembly 70 may be separated from a motor assembly 30 according to an example embodiment. The filter assembly 70 may include a filter support 8, a filter, and a side housing 302. The filter support 8 may support the filter 7 within the filter 7. The side housing 302 may cover the filter 7 from the outside of the filter 7. The user may separate or couple the filter assembly 70 from or to a motor frame (e.g., the motor assembly 30) as needed. However, the separation and coupling of the filter assembly 70 is not limited to the above description.

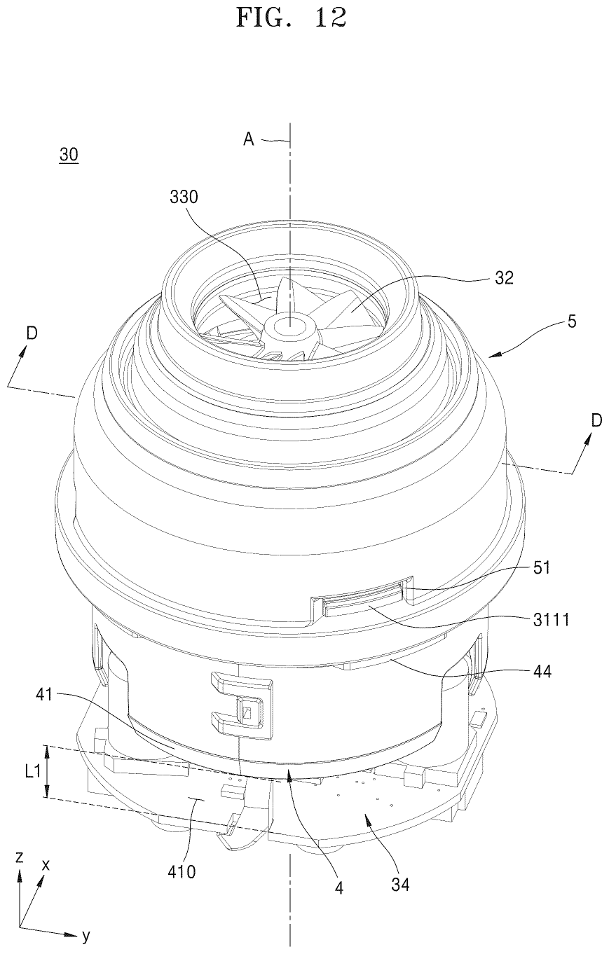

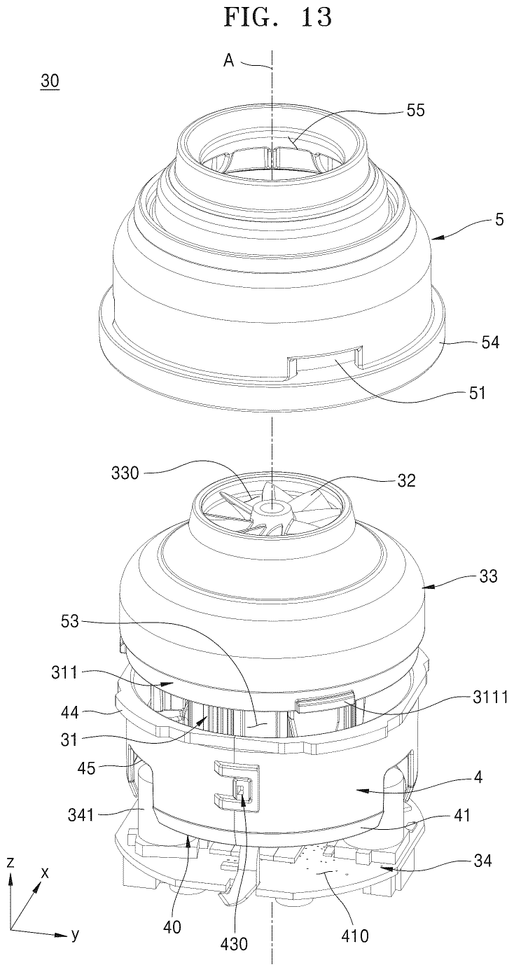

FIG. 12 is a perspective view of a motor assembly viewed from a different angle according to an embodiment of the disclosure. FIG. 13 is an exploded perspective view showing a guide cover separated from the motor assembly of FIG. 12 according to an embodiment of the disclosure.

Referring to FIGS. 12 and 13, a motor assembly 30 according to an example embodiment may include a fan motor 31, an impeller 32, and the fifth suction portion 330.

The fan motor 31 may supply rotation force to the impeller 32.

The impeller 32 may be rotated by the fan motor 31. The impeller 32 may be rotated by the fan motor 31 to generate suction force in the motor assembly 30. The impeller 32 may be rotated by the fan motor 31 to generate suction force in the fifth suction portion 330.

The motor assembly 30 may generate suction force through the fifth suction portion 330. The motor assembly 30 may provide suction force through the fifth suction portion 330. The motor assembly 30 may suck in air through the fifth suction portion 330. The motor assembly 30 may suck in air in the axial direction A. The axial direction A may be the axial direction A of the impeller 32.

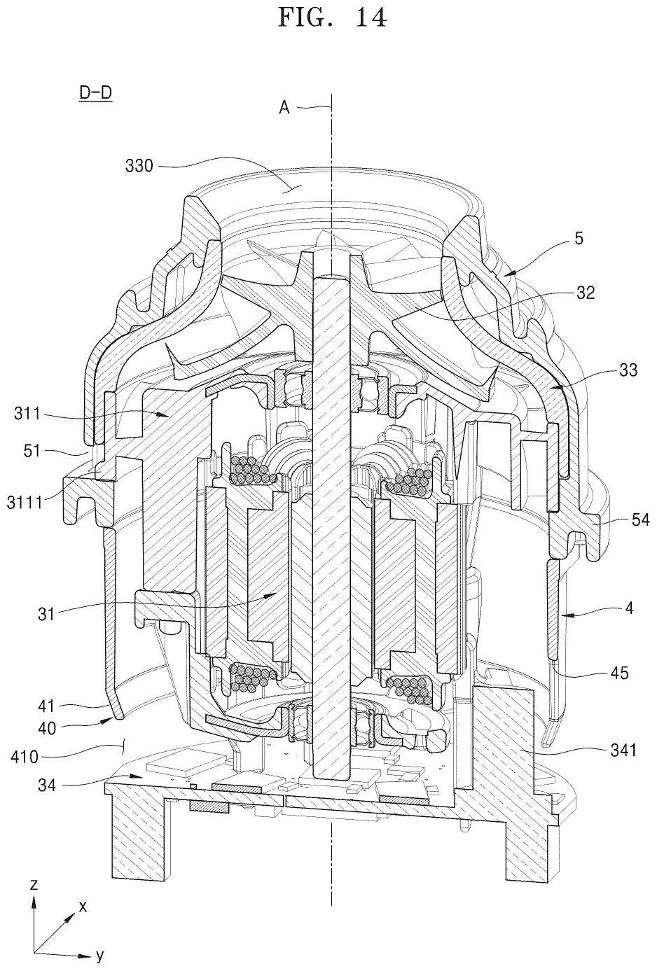

FIG. 14 is a cross-sectional perspective view of a cross section D-D of the motor assembly of FIG. 12 according to an embodiment of the disclosure.

Referring to FIGS. 10 and 12 to 14, a motor assembly 30 according to an example embodiment may include a control board 34. The control board 34 may control the operation of the motor assembly 30. The control board 34 may control the operation of the fan motor 31. The control board 34 may supply power to the fan motor 31. The control board 34 may be disposed below the fan motor 31. A lower portion of the fan motor 31, in which the control board 34 is disposed, may be toward the fan motor in the axial direction A in which the impeller 32 is connected to the fan motor 31. The fan motor 31 may be located between the impeller 32 and the control board 34. However, the arrangement direction of the control board 34 is not limited to the above description.

The fan motor 31 may be located above the control board 34. The fan motor 31 may be located above the control board 34. The control board 34 may be supported on the support frame 6. The control board 34 may be supported on the lower housing 303. The control board 34 may be supported on the filter support 8. However, the function and arrangement of the control board 34 are not limited to the above description.

The motor assembly 30 according to an example embodiment may include a first guide 33. The first guide 33 may cover the impeller 32. The first guide 33 may protect the impeller 32. The first guide 33 may be located above the control board 34. The first guide 33 may be located above the fan motor 31. However, the arrangement of the first guide 33 is not limited to the above description.

The first guide 33 according to an example embodiment may guide sucked-in air in the axial direction A of the impeller 32 along a flow path. The first guide 33 may guide the sucked-in air in the axial direction A of the impeller 32 along the air flow path to be directed to the control board 34. However, the arrangement and function of the first guide 33 are not limited to the above description.

The motor assembly 30 according to an example embodiment may include a second guide 4. The second guide 4 may cover the fan motor 31. The second guide 4 may protect the fan motor 31. The second guide 4 may guide air along an air flow path. The second guide 4 may guide the air along the air flow path to be directed toward the control board 34. The second guide 4 may guide the air sucked in by the motor assembly 30 along the air flow path such that the air may reach the control board 34. The second guide 4 may be located below the first guide 33. The second guide 4 may be located between the first guide 33 and the control board 34. The second guide 4 may be located above the control board 34. However, the function and arrangement of the second guide 4 are not limited to the above description.

The second guide 4 according to an example embodiment may be located apart from the first guide 33. When the second guide 4 according to an example embodiment is located apart from the first guide 33, the fan motor 31 may be exposed to the outside. However, the arrangement relationship of the first guide 33 and the second guide 4 is not limited to the above description.

The motor assembly 30 according to an example embodiment may include a guide gap 53 defined by a space between the first guide 33 and the second guide 4. The guide gap 53 may be the space between the first guide 33 and the second guide 4. The fan motor 31 may be exposed to the outside through the guide gap 53. However, whether there is a space between the first guide 33 and the guide and whether the fan motor 31 is exposed are not limited to the above description. For example, there may be no space between the first guide 33 and the second guide 4. For example, the first guide 33 and the second guide 4 may be one body.

The motor assembly 30 according to an example embodiment may include the guide cover 5 surrounding the first guide 33. The guide cover 5 may cover the first guide 33. The guide cover 5 may surround an outer surface of the first guide 33. The guide cover 5 may be disposed on the first guide 33. The guide cover 5 may be disposed on a surface of the first guide 33. However, the arrangement of the guide cover 5 is not limited to the above description.

The guide cover 5 according to an example embodiment may include an accommodation portion 54 at a lower end. The accommodation portion 54 may be a portion at which the guide cover 5 comes into contact with the second guide 4. The accommodation portion 54 may be a portion at which the guide cover 5 is accommodated on an upper end of the second guide 4. The accommodation portion 54 may be a portion at which the guide cover 5 is supported by the upper end of the second guide 4. However, the arrangement of the accommodation portion 54 is not limited to the above description.

The guide cover 5 according to an example embodiment may cover a space between the first guide 33 and the second guide 4. The guide cover 5 may cover the guide gap 53. The guide cover 5 may seal the space between the first guide 33 and the second guide 4. The guide cover 5 may guide the air sucked in by the motor assembly 30 along the air flow path to be directed toward the control board 34. The guide cover 5 may provide the air flow path such that the air sucked in by the motor assembly 30 may pass through the first guide 33 and be directed toward the second guide 4. The guide cover 5 may prevent air sucked in by the motor assembly 30 from leaking out through the guide gap 53. However, the function of the guide cover 5 is not limited to the above description.

The fan motor 31 of the motor assembly 30 according to an example embodiment may be a high-performance fan motor 31. The high-performance fan motor 31 may provide high output to the impeller 32 such that the motor assembly 30 may provide strong suction force. The high-performance fan motor 31 may provide a high rotation speed to the impeller 32 such that the motor assembly 30 may provide strong suction force. The rotation speed of the fan motor 31 may be 60,000 RPM or more and 138,000 RPM or less. The power consumption of the fan motor 31 may be 55 W or more and 580 W or less. When the fan motor 31 is a high-performance fan motor 31, it may be necessary to reduce the noise occurring during an operation of the fan motor 31. However, the performance, rotation speed, output, and noise occurrence of the fan motor 31 are not limited to the above description.

The first guide 33 according to an example embodiment may be located adjacent to the impeller 32. The impeller 32 may produce noise and vibration through rotation. The impeller 32 may transfer noise and vibration to the first guide 33. The first guide 33 may receive noise and vibration by the impeller 32.

The guide cover 5 according to an example embodiment may include an elastic material. The guide cover 5 may prevent the first guide 33 from transferring noise and vibration to the outside. The guide cover 5 may alleviate vibration of the first guide 33. The guide cover 5 may alleviate vibration of the first guide 33 through elastic deformation. The guide cover 5 may function as a damper for vibration of the first guide 33. The guide cover 5 may alleviate noise of the first guide 33. However, the function of the guide cover 5 is not limited to the above description.

The guide cover 5 according to an example embodiment may include an opening 55. The guide cover 5 may include the opening 55 through which the fifth suction portion 330 is exposed. The guide cover 5 may not reduce the suction force generated by the motor assembly 30. The guide cover 5 may reduce noise and vibration of the motor assembly 30. However, the function of the guide cover 5 is not limited to the above description.

Referring back to FIGS. 10 and 13, the second guide 4 according to an example embodiment may include a fixing protrusion 44. The support frame 6 may include a fixing groove 64. The second guide 4 may be supported on the support frame 6. The fixing protrusion 44 may be accommodated in the fixing groove 64. The support frame 6 may support the second guide 4. The support frame 6 may cover the second guide 4. However, the support relationship between the second guide 4 and the support frame 6 is not limited to the above description.

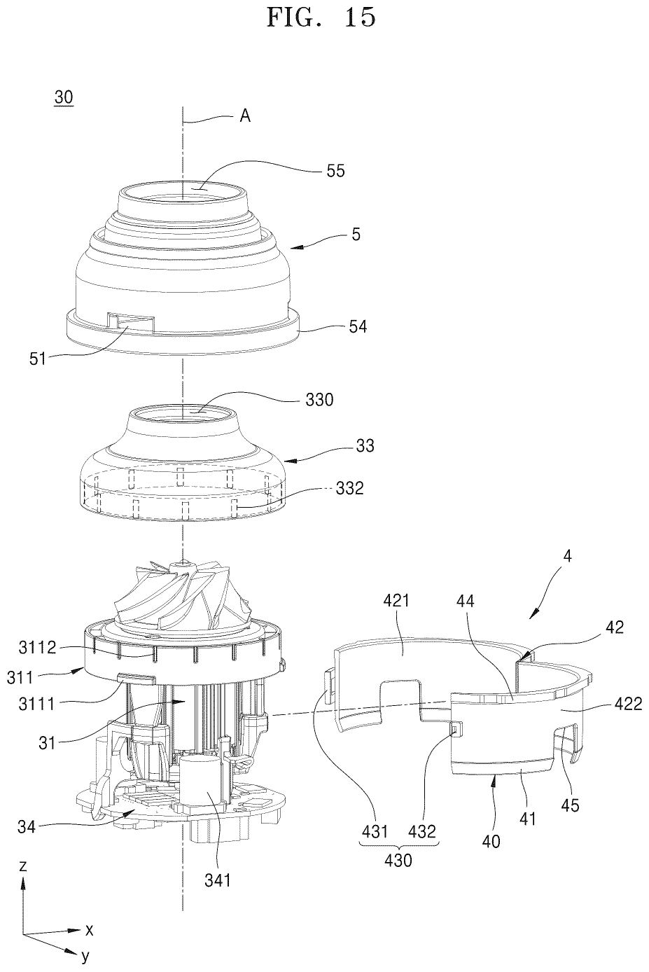

FIG. 15 is an exploded perspective view of a state in which a first guide and a second guide are separated from the motor assembly of FIG. 12 viewed from different directions according to an embodiment of the disclosure.

Referring to FIGS. 12 to 15, a fan motor 31 according to an example embodiment may include a motor frame 311. The motor frame 311 may connect the fan motor 31 to an impeller 32. The motor frame 311 may be located between the fan motor 31 and the impeller 32. The motor frame 311 may support the fan motor 31.

The motor frame 311 according to an example embodiment may include a second protrusion 3111. The guide cover 5 may include a second groove 51. The guide cover 5 may be fixed to the motor frame 311. The second protrusion 3111 may be fastened to the second groove 51. The guide cover 5 may be fixed to the motor frame 311 by fastening the second protrusion 3111 to the second groove 51. However, the fixing of the guide cover 5 and the motor frame 311 is not limited to the above description.

The motor frame 311 according to an example embodiment may include a third protrusion 3112. The first guide 33 may include a third groove 332. The first guide 33 may be fixed to the motor frame 311. The third protrusion 3112 may be fastened to the third groove 332. The first guide 33 may be fixed to the motor frame 311 by fastening the third protrusion 3112 to the third groove 332. However, the fixing of the first guide 33 and the motor frame 311 is not limited to the above description.

Referring back to FIGS. 10, 12 to 14, an end 40 of the second guide 4 according to an example embodiment may be located to face the control board 34. The second guide 4 may be located apart from the control board 34. The second guide 4 may be located apart from the control board 34 at a certain interval. An interval L1 between the second guide 4 and the control board 34 may be 4 mm or more. The interval L1 between the second guide 4 and the control board 34 may be 5 mm or more. The interval L1 between the second guide 4 and the control board 34 may be 20 mm or less. The interval L1 between the second guide 4 and the control board 34 may be 10 mm or less. The interval L1 at which the second guide 4 is spaced apart from the control board 34 may be the interval L1 at which the end 40 of the second guide 4 is spaced apart from the control board 34. However, the positional relationship between the second guide 4 and the control board 34 is not limited to the above description.

The motor assembly 30 according to an example embodiment may include a lower gap 410. The lower gap 410 may be a gap defined by a space between the control board 34 and the second guide 4. The space between the control board 34 and the second guide 4 may define the lower gap 410. The lower gap 410 may be a passage through which air sucked in by the motor assembly 30 is discharged. The air sucked in by the motor assembly 30 may flow into the lower gap 410 by the control board 34. The control board 34 may discharge the air sucked in by the motor assembly 30 into the lower gap 410. When the lower gap 410 is equal to or greater than a certain interval, the air sucked in by the motor assembly 30 may be discharged smoothly through the lower gap 410. When the interval L1 of the lower gap 410 is equal to or greater than a certain length, the air sucked in by the motor assembly 30 may be discharged smoothly. When the interval L1 of the lower gap 410 is equal to or greater than 4 mm, the air sucked in by the motor assembly 30 may be discharged smoothly through the lower gap 410. When the interval L1 of the lower gap 410 is equal to or greater than 5 mm, the air sucked in by the motor assembly 30 may be discharged smoothly through the lower gap 410. However, the interval L1 of the lower gap 410 and the discharge of air are not limited to the above description.

The control board 34 according to an example embodiment may change a flow direction of air sucked in by the motor assembly 30 from the axial direction A to a radial direction. The direction in which the air sucked in by the motor assembly 30 flows may be radially refracted from the control board 34. The radial direction may be a direction that intersects with the axial direction A. The radial direction may be perpendicular to the axial direction A. However, the flow direction of the air sucked in by the motor assembly 30 is not limited to the above description.

The relationship between cooling provided to the second guide 4 and the control board 34 will be described exemplarily below.

When the fan motor 31 according to an example embodiment is a high-performance fan motor 31, the amount of power that the control board 34 needs to supply to the fan motor 31 may be large. When the fan motor 31 is the high-performance fan motor 31, the amount of heat generated in the control board 34 may be large. When the amount of heat generated in the control board 34 is large, cooling may need to be provided to the control board 34. However, a degree of heat generated from the control board 34 is not limited to the above description. For example, a need for cooling of the control board 34 and the performance of the fan motor 31 may be unrelated.

The second guide 4 according to an example embodiment may provide cooling to the control board 34. When the air sucked in by the motor assembly 30 reaches the control board 34 through the second guide 4, the control board 34 may be cooled. When the second guide 4 guides the flow of air toward the control board 34, the control board 34 may be cooled. The air sucked in by the motor assembly 30 may cool the control board 34. The air sucked in by the motor assembly 30 may cool the control board 34 by reaching the control board 34 through the flow path along which air is guided by the second guide 4. However, the relationship between the cooling of the control board 34 and the air sucked in by the motor assembly 30 is not limited to the above description.

The second guide 4 according to an example embodiment may include a nozzle portion 41 at the end 40. The nozzle portion 41 may be a portion having an area that reduces toward the control board 34. The nozzle portion 41 may be a portion that increases the speed of air directed toward the control board 34. The nozzle portion 41 may be a portion that increases the pressure of air directed toward the control board 34. The nozzle portion 41 may be a portion that changes the direction of air flow toward the control board 34.

The nozzle portion 41 according to an example embodiment may be configured to condense the air sucked in by the motor assembly 30. The nozzle portion 41 may have a gradient of a certain angle D with respect to the second guide 4. The nozzle portion 41 may have a gradient of a certain angle D with respect to the end 40 of the second guide 4. The nozzle portion 41 may have a gradient in the axial direction A. The nozzle portion 41 may have a shape that is bent in a direction in which the diameter of the second guide 4 decreases. The angle D of the gradient of the nozzle portion 41 may be an angle D formed between the second guide 4 and a straight line connecting two ends of the nozzle portion 41. The angle D of the gradient of the nozzle portion 41 may be an angle D formed between the axial direction A and the straight line connecting two ends of the nozzle portion 41. However, the shape of the nozzle portion 41 is not limited to the above description. For example, the nozzle portion 41 may have a curved gradient.

The air sucked in by the motor assembly 30 according to an example embodiment may flow along the inner surface of the second guide 4 to the control board 34. The air sucked in by the motor assembly 30 may be refracted by the nozzle portion 41. The air sucked in by the motor assembly 30 may have a flow speed increased by the nozzle portion 41. The air sucked in by the motor assembly 30 may have a pressure increased by the nozzle portion 41. The air sucked in by the motor assembly 30 may be condensed by the nozzle portion 41. The air sucked in by the motor assembly 30 may have a density increased by the nozzle portion 41. However, the relationship between a flow of air sucked in by the motor assembly 30 and the nozzle portion 41 is not limited to the above description.

The nozzle portion 41 according to an example embodiment may provide a flow of air having a high degree of cohesion to the control board 34. The nozzle portion 41 may provide a flow of air having a high density to the control board 34. When a flow of air having a high cohesion is provided to the control board 34, the cooling degree of the control board 34 may be high. When a flow of air having a high density is provided to the control board 34, the cooling degree of the control board 34 may be high. The nozzle portion 41 may guide a flow of air to provide a high cooling degree to the control board 34. However, the relationship between the cooling of the control board 34 and the nozzle portion 41 is not limited to the above description.

The relationship between the second guide 4 and noise reduction of the motor assembly 30 will be described exemplarily below.

When the fan motor 31 according to an example embodiment is the high-performance fan motor 31, noise prevention may be required. However, the performance and noise occurrence of the motor assembly 30 are not limited to the above description.

The noise from the motor assembly 30 according to an example embodiment may be transferred to the outside through the lower gap 410. The noise from the motor assembly 30 may be transferred to the outside through the air discharged through the lower gap 410. When the noise from the motor assembly 30 does not reach the control board 34 but is transferred through the lower gap 410, the noise may be excessive. When the noise of the motor assembly 30 transferred toward the control board 34 spreads widely in a radial direction, the noise transferred to the outside may be excessive.

The nozzle portion 41 according to an example embodiment may prevent noise of the motor assembly 30, transferred toward the control board 34, from spreading widely in a radial direction. The nozzle portion 41 may prevent noise from the motor assembly 30 from being transferred to the lower gap 410. The nozzle portion 41 may induce the noise of the motor assembly 30 to hover over the control board 34. The noise of the motor assembly 30, which hovers over the control board 34, may hover between the components arranged on the control board 34. The noise of the motor assembly 30 may be attenuated by the components arranged on the control board 34. The noise of the motor assembly 30 may be dampened by the components arranged on the control board 34. The nozzle portion 41 may reduce the noise of the motor assembly 30. However, the relationship between the noise of the nozzle portion 41 and the motor assembly 30 is not limited to the above description.

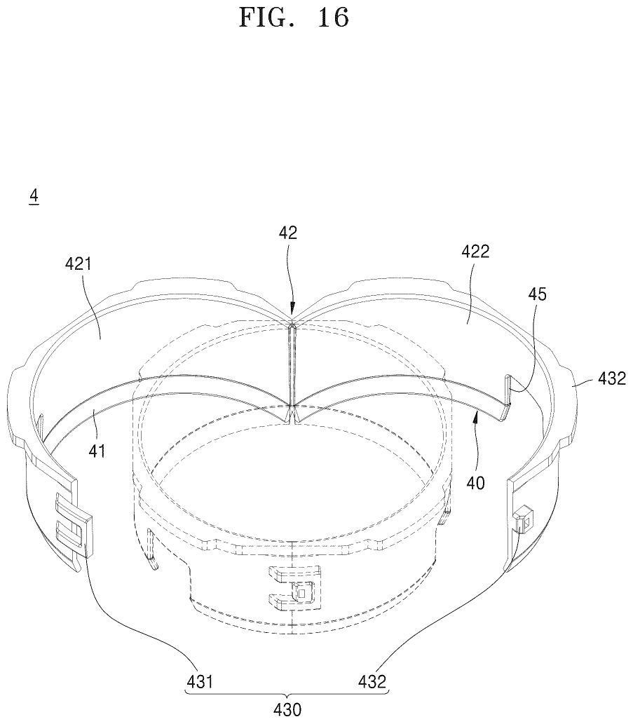

FIG. 16 is a perspective view illustrating an operation of a clip portion of a second guide according to an embodiment of the disclosure.

Referring to FIGS. 15 and 16, a second guide 4 according to an example embodiment may be assembled to a fan motor 31. The second guide 4 may be assembled to surround the fan motor 31. The second guide 4 may be assembled to the fan motor 31 by being fastened to the outside of the fan motor 31. The second guide 4 may be fastened to the outside of the fan motor 31. The second guide 4 may be fastened to surround the fan motor 31. The second guide 4 may be fixed to the fan motor 31 by being fixedly located outside the fan motor 31. However, the assembly of the second guide 4 is not limited to the above description.

The second guide 4 according to an example embodiment may include an avoidance portion 45. The second guide 4 may have a concave structure such that the avoidance portion 45 avoids an interference member 341 of the control board 34. The interference member 341 may be an electrical device disposed on the control board 34. The interference member 341 may have a structure protruding toward the fan motor 31 on the control board 34. The second guide 4 may include the avoidance portion 45 having a concave structure to prevent interference with the interference member 341 of the control board 34. When the second guide 4 is assembled to the fan motor 31, the second guide 4 may not interfere with the interference member 341 of the control board 34. However, the structure and arrangement of the interference member 341 and the avoidance portion 45 are not limited to the above description.

The second guide 4 according to an example embodiment may include a clip portion 430. The clip portion 430 may be configured to fasten two side ends 43 of the second guide 4. The clip portion 430 may fix the two side ends 43 of the second guide 4. The clip portion 430 may include a fourth groove 431 and a fourth protrusion 432. The fourth protrusion 432 may be inserted into the fourth groove 431. The fourth protrusion 432 may be fixed to the fourth groove 431. The fourth protrusion 432 and the fourth groove 431 may be fixed through hook coupling. The fourth protrusion 432 may be located at one side end 43 of the second guide 4, and the fourth groove 431 may be located on the other side end 43 of the second guide 4. However, the function and structure of the side ends 43 of the second guide 4 are not limited to the above description.

The second guide 4 according to an example embodiment may include a link 42. The link 42 may be flexible. The second guide 4 may be curved based on the link 42. The second guide 4 may be bent based on the link 42. The second guide 4 may be divided into a first part 421 and a second part 422 based on the link 42. The first part 421 and the second part 422 may rotate around the link 42. The link 42 may provide a rotatable structure such that an end of the first part 421 and an end of the second part 422 may be in contact with each other. The fourth groove 431 may be located at the end of the first part 421. The fourth protrusion 432 may be located at the end of the second part 422. However, the function and structure of the link 42 are not limited to the above description.

The clip portion 430 of the second guide 4 according to an example embodiment may fasten the two side ends 43 of the second guide 4 as the link 42 is curved. However, the curving of the link 42 and the fastening of the clip portion 430 are not limited to the above description.

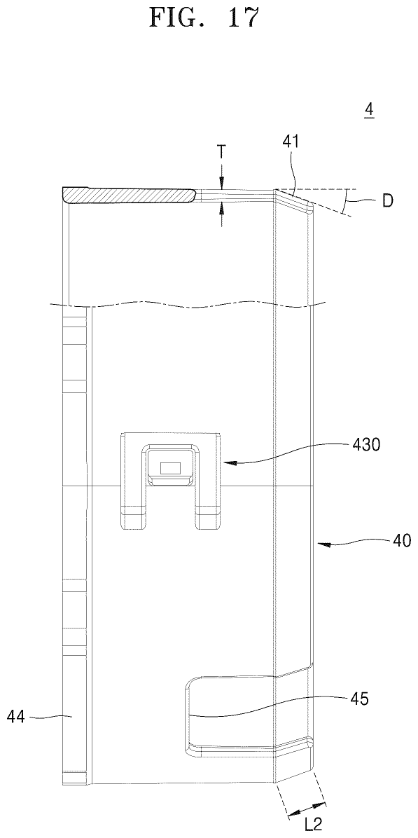

FIG. 17 is a partial cross-sectional view of a second guide according to an embodiment of the disclosure.

Referring to FIGS. 15 to 17, a second guide 4 according to an example embodiment may have a certain thickness T. The thickness T of the second guide 4 may be 1 mm or more and 3 mm or less. The thickness T of the second guide 4 may be 1.5 mm or more and 2.5 mm or less. However, the thickness T of the second guide 4 is not limited to the above description.

The nozzle portion 41 of the second guide 4 according to an example embodiment may have a certain length L2. The length L2 of the nozzle portion 41 may be 1 mm or more. The length L2 of the nozzle portion 41 may be 1.5 mm or more. The length L2 of the nozzle portion 41 may be 2 mm or more. The length L2 of the nozzle portion 41 may be 3 mm or more. The length L2 of the nozzle portion 41 may be 10 mm or less. The length L2 of the nozzle portion 41 may be 5 mm or less. However, the length L2 of the nozzle portion 41 is not limited to the above description.

The nozzle portion 41 of the second guide 4 according to an example embodiment may have a gradient of a certain angle D. The gradient of the certain angle D of the nozzle portion 41 may be 5° or more and 60° or less. The gradient of the certain angle D of the nozzle portion 41 may be 100 or more and 400 or less. The gradient of the certain angle D of the nozzle portion 41 may be 150 or more and 300 or less. However, the gradient of the certain angle D of the nozzle portion 41 is not limited to the above description.

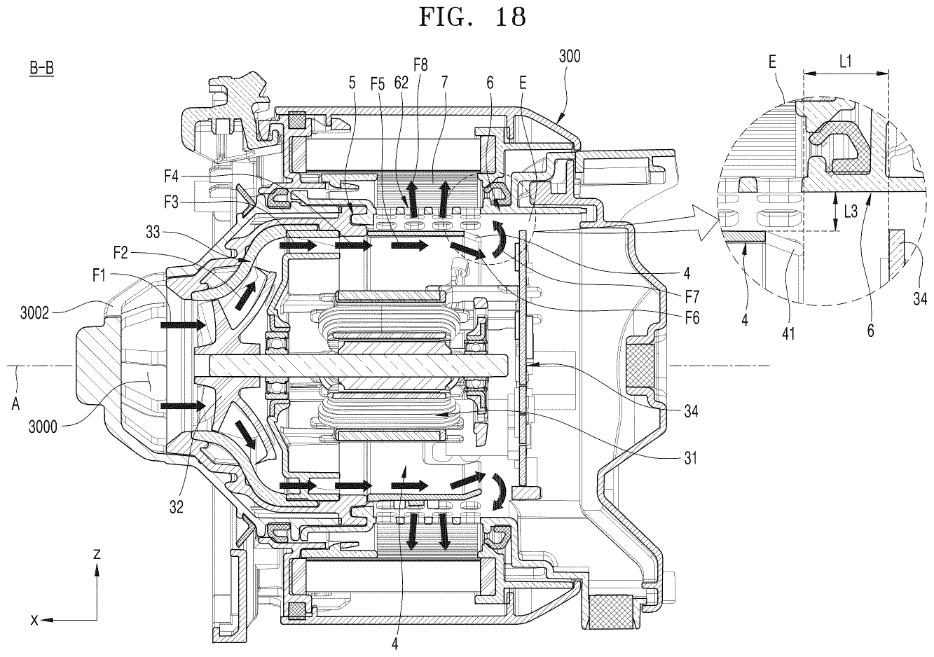

FIG. 18 is a cross-sectional view of the motor portion of FIG. 6 viewed in B-B direction according to an embodiment of the disclosure.

Referring to FIGS. 6, 10, 12, 13, 14, 17, and 18, a motor portion 3 according to an example embodiment may be configured to suck in air from a fourth suction portion 3000 and discharge the air to a discharge portion 3001. The motor portion 3 may provide an internal flow path to allow the sucked-in air to flow. The air sucked in by the motor portion 3 from the fourth suction portion 3000 may flow through the internal flow path and be discharged to the discharge portion 3001. However, the flow of air sucked in by the motor portion 3 is not limited to the above description.

The internal flow path of the motor portion 3 according to an example embodiment may include a first flow path F1 passing through the fourth suction portion 3000 and directed toward the impeller 32. The internal flow path may include a second flow path F2 passing through the impeller 32 and directed toward the first guide 33. The internal flow path may include a third flow path F3 passing through the first guide 33 and directed toward the guide gap 53. The internal flow path may include a fourth flow path F4 passing through the guide gap 53 and directed toward the second guide 4. The internal flow path may include a fifth flow path F5 passing through the second guide 4 and directed toward the control board 34. The internal flow path may include a sixth flow path F6 passing through the end 40 of the second guide 4 and directed toward the control board 34. The internal flow path may include a seventh flow path F7 passing through the control board 34 and directed toward the discharge hole 62. The internal flow path may include an eighth flow path F8 passing through the discharge hole 62 and directed toward the filter 7. However, the internal flow path of the motor portion 3 is not limited to the above description.

The sixth flow path F6 according to an example embodiment may pass through the end 40 of the second guide 4 and be directed toward the control board 34. The internal flow path may include the sixth flow path F6 passing through the nozzle portion 41 of the second guide 4 and directed toward the control board 34. The sixth flow path F6 may pass through the nozzle portion 41 of the second guide 4 and be directed toward the control board 34. The air sucked in by the motor portion 3 may flow through the sixth flow path F6 and be condensed. The air sucked in by the motor portion 3 may condense in the axial direction A as the air passes through the sixth flow path F6. The air sucked in by the motor portion 3 may pass through the sixth flow path F6 and a flow rate of the air may increase. The air sucked in by the motor portion 3 may pass through the sixth flow path F6 and a density of the air may increase. The air sucked in by the motor portion 3 may pass through the sixth flow path F6 and cool the control board 34. The air sucked in by the motor portion 3 may exchange heat with the control board 34 through the sixth flow path F6. However, the flow of air sucked in by the motor portion 3 is not limited to the above description.

A flow of air sucked in by the motor portion 3 may reach the control board 34 according to an example embodiment. The control board 34 may change a direction of flow of air sucked in by the motor portion 3. The control board 34 may reflect the flow of air sucked in by the motor portion 3. The flow of air sucked in by the motor portion 3 may pass through the sixth flow path F6 and be reflected by the control board 34. The control board 34 may reflect the flow of air sucked in by the motor portion 3 and direct the air toward the discharge hole 62. The control board 34 may reflect the flow of air sucked in by the motor portion 3 and direct the air toward the lower gap 410. The control board 34 may reflect the flow of air sucked in by the motor portion 3 and direct the air toward the seventh flow path F7. However, the control board 34 and the flow of air are not limited to the above description.

The seventh flow path F7 according to an example embodiment may pass through the control board 34 and be directed toward the discharge hole 62. The internal flow path may include the seventh flow path F7 passing through the control board 34 and directed toward the control support frame 6. The seventh flow path F7 may pass through the control board 34 and be directed toward the support frame 6. The air sucked in by the motor portion 3 may be directed toward the discharge hole 62 included in the support frame 6 after cooling the control board 34. However, the flow of air in the seventh flow path F7 is not limited to the above description.

An enlarged view E of FIG. 18 is an enlarged view for explaining an interval between the second guide 4 and the support frame 6 according to an example embodiment.

Referring to the enlarged view E, the second guide 4 according to an example embodiment may be located at a certain interval L3 from the support frame 6. The second guide 4 may be located at the certain interval L3 from the discharge hole 62. The end 40 of the second guide 4 may be located at the certain interval L3 from the support frame 6. The end 40 of the second guide 4 may be located at the certain interval L3 from the discharge hole 62. The nozzle portion 41 may be located at the certain interval L3 from the support frame 6. The nozzle portion 41 may be located at the certain interval L3 from the discharge hole 62. The certain interval L3 may be 1 mm or more and 10 mm or less. The certain interval L3 may be 1.5 mm or more and 8 mm or less. The certain interval L3 may be 2 mm or more and 5 mm or less. However, the certain interval L3 is only an example embodiment and is not limited thereto.

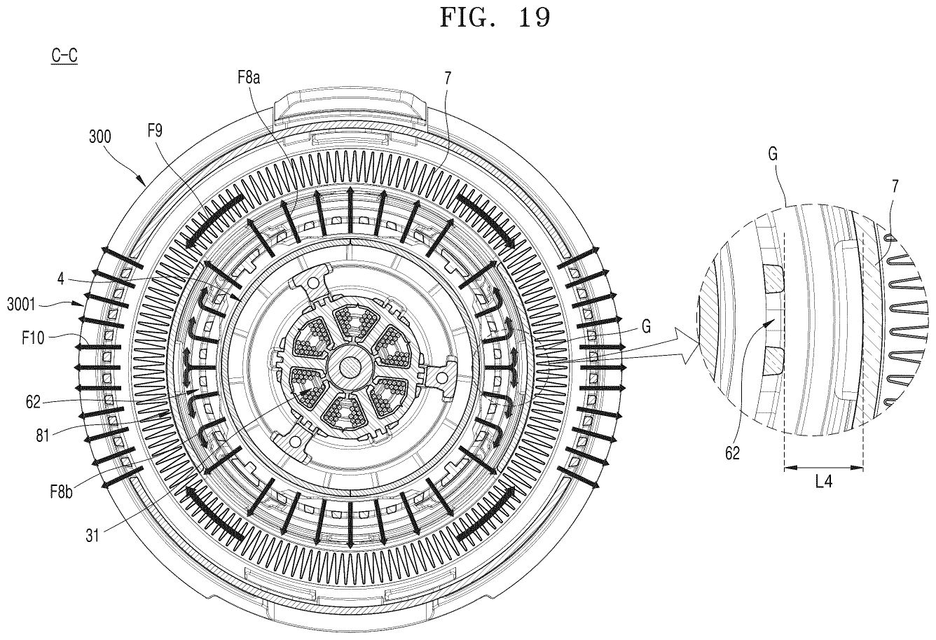

FIG. 19 is a cross-sectional view of the motor portion of FIG. 6 viewed in C-C direction according to an embodiment of the disclosure.

Referring to FIGS. 6, 10, 12, 13, 14 and 17 to 19, the internal flow path of a motor portion 3 according to an example embodiment may include an eighth flow path F8 configured to pass through a discharge hole 62. The eighth flow path F8 may include a direct flow path F8a and a bypass flow path F8b. The direct flow path F8a may be a flow path that does not face the discharge portion 3001 of the motor portion 3. The bypass flow path F8b may be a flow path facing the discharge portion 3001 of the motor portion 3. The direct flow path F8a may be a flow path in which air passing through the discharge hole 62 flows directly toward the filter 7. The bypass flow path F8b may be a flow path through which air passing through the discharge hole 62 moves along an inner circumferential surface of the barrier 81 toward the filter 7. The barrier 81 may prevent air passing through the bypass flow path F8b from flowing directly toward the discharge portion 3001. The barrier 81 may reduce the noise of the air discharged by the motor portion 3. However, the configuration and arrangement of the barrier 81 and the bypass flow path F8b are not limited to the above description.

The internal flow path of the motor portion 3 according to an example embodiment may include a ninth flow path F9 passing through the filter 7 and directed toward the discharge hole 62. The ninth flow path F9 may pass through the filter 7 and be directed toward the discharge hole 62. The air sucked in by the motor portion 3 may pass through the ninth flow path F9, and internal noise may be reduced. The ninth flow path F9 may reduce noise inside the motor portion 3. However, the configuration and function of the ninth flow path F9 are not limited to the above description.

The internal flow path of the motor portion 3 according to an example embodiment may include a tenth flow path F10 configured to discharge air through the discharge portion 3001. The tenth flow path F10 may be a flow path passing through the discharge portion 3001. The tenth flow path F10 may discharge the air sucked in by the fourth suction portion 3000 of the motor portion 3 through the discharge portion 3001. However, the arrangement of the tenth flow path F10 is not limited to the above description.

An enlarged view G of FIG. 19 is an enlarged view for explaining an interval L4 between the discharge hole 62 and the barrier 81 according to an example embodiment.

Referring to the enlarged view G, the discharge hole 62 according to an example embodiment may be located at a certain interval L4 from the barrier 81. The certain interval L4 may be 1 mm or more and 10 mm or less. The certain interval L4 may be 1.5 mm or more and 8 mm or less. The certain interval L4 may be 2 mm or more and 5 mm or less. When the discharge hole 62 and the barrier 81 are located at the certain interval L4, air passing through the bypass flow path F8b may flow smoothly. However, the certain interval L4 is only an example embodiment and is not limited thereto.

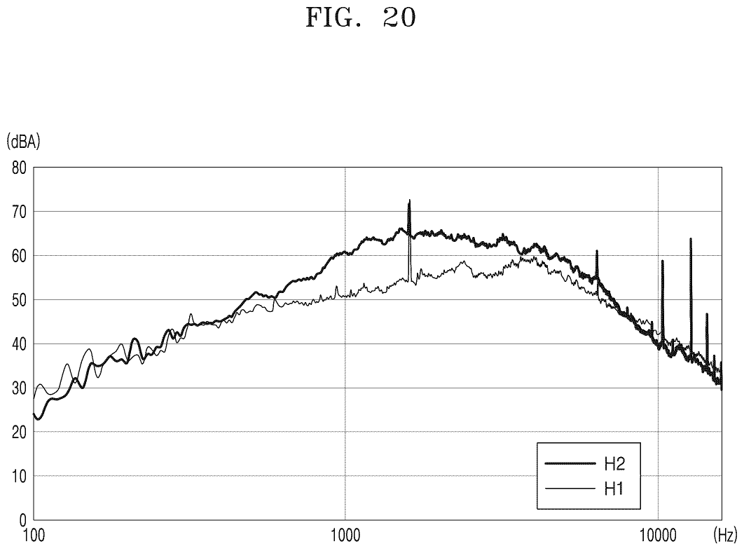

FIG. 20 is a diagram for explaining noise of a motor assembly according to an embodiment of the disclosure. In FIG. 20, the horizontal axis of the graph may be the frequency of noise. A unit of frequency may be hertz (Hz). The vertical axis of the graph may be the magnitude of the noise. A unit of noise level may be decibel (dBA).

Referring to FIG. 20, a plot obtained by measuring noise of a motor assembly 30 according to an embodiment including a second guide 4 (see FIG. 10) and a filter support 8 (see FIG. 10) is indicated as H1. The second guide 4 according to an embodiment includes a nozzle portion 41 (see FIG. 17) located at an end 40, and a length L2 of the nozzle portion 41 is about 3 mm, and the angle D of the nozzle portion 41 is about 20°.

A plot obtained by measuring the noise of the motor assembly 30 according to a comparative example is indicated as H2. The motor assembly according to the comparative example is the same as the motor assembly 30 according to an embodiment except that the motor assembly according to the comparative example does not include the nozzle portion 41 and the filter support 8.

Referring to FIG. 20, a converted noise value of H1 is 83.5 dB. A converted noise value of H2 is seen to be 88.8 dB. The motor assembly 30 including the nozzle portion 41 (see FIG. 17) and a blocking portion may reduce noise by about 5.3 dB. However, the above description is only a noise reduction effect and is not limited thereto.

The converted noise value may be a noise value converted from separate noise values measured for respective frequencies. The converted noise value may be the sum of the separate noise values. The converted noise value may be the sum of the total amplitudes of the separate noise values. The converted noise value may be a value obtained by summing separate noise values by using the dB summation method. The dB summation method may be represented based on the following equation.

$$\text{?} 10 log ( 1 \text{?} + 1 \text{?} + … + 1 \text{?} ) \qquad Equation 1$$

$$\text{?} \text{indicates text missing or illegible when filed}$$

In this case, dB₁ to dBₙ may be separate noise values. The separate noise value may be a value obtained by converting a difference in vibration acceleration for each frequency. The separate noise value may be a value obtained by applying a weight for each frequency. The separate noise value may be a vibration level, a sound pressure level, or a sound power level.

However, the converted noise value is not limited to the above description.

The motor assembly 30 including the nozzle portion 41 and the blocking portion according to an example embodiment may have a noise reduction effect. The motor assembly 30 including the nozzle portion 41 and the blocking portion may have a significant noise reduction effect at 600 Hz to 3000 Hz. However, the above description is only a range and is not limited thereto.

The above embodiments are only exemplary, and those of skill in the art will understand that various modifications and equivalent other embodiments are possible therefrom. Therefore, the true technical scope of the disclosure should be determined by the technical spirit of the appended claims.

A motor assembly according to an example embodiment may be configured to generate suction force in a vacuum cleaner.

A motor assembly according to an example embodiment may include a control board, a fan motor disposed on the control board, an impeller that is rotated by the fan motor, a first guide that covers the impeller and guides sucked-in air in an axial direction of the impeller along an air flow path to be directed to the control board, and a second guide disposed between the first guide and the control board to cover the fan motor and guide the air flow path, wherein the second guide is located apart from the control board and includes a nozzle portion having a gradient of a certain angle with respect to the axial direction at an end facing the control board.

The gradient of the certain angle with respect to the axial direction of the nozzle portion may be 5° to 60°.

A length of the nozzle portion may be 2 mm or more.

A thickness of the second guide may be 1 mm or more and 3 mm or less.

An interval between the second guide and the control board may be 5 mm.

The second guide may include a clip portion and a flexible link, and the clip portion may be configured to fasten two end portions of the second guide as the link is curved.

The motor assembly may further include a guide cover surrounding the first guide, and the guide cover may include an elastic material.

The guide cover may seal a space between the first guide and the second guide.

The motor assembly may further include a support frame covering the second guide, and the support frame includes a plurality of discharge holes arranged along an outer circumferential surface.

The motor assembly may further include a housing including a suction portion in the axial direction and a discharge portion in a radial direction that intersects with the axial direction and constituting an outer appearance of the motor assembly.

The motor assembly may further include a filter disposed between the support frame and the housing, and the filter may be configured to collect foreign substances discharged to the discharge portion.

The motor assembly may further include a filter support disposed between the filter and the support frame, to support the filter, and

The filter support may include a barrier that covers, from an outside, the discharge hole located to face discharge portion among the plurality of discharge holes.

An interval between the barrier and the discharge hole may be 4 mm or more and 6 mm or less.

A dust collection device according to an example embodiment may be configured to generate suction force in a vacuum cleaner and temporarily store foreign substances sucked in by the vacuum cleaner.

A dust collection device according to an example embodiment may include a motor portion including a motor assembly, and a dust collector configured to separate foreign substances from air sucked in by the vacuum cleaner and temporarily store the foreign substances.

A vacuum cleaner according to an example embodiment may include a suction device configured to suck in foreign substances, a vacuum cleaner body including the dust collection device and configured to store the foreign substances sucked in through the suction device, and a transfer portion disposed between the suction device and the vacuum cleaner body and configured to transfer sucked-in foreign substances from the suction device to the vacuum cleaner body.

A vacuum cleaner according to an example embodiment may provide a small-sized vacuum cleaner.

A dust collection device according to an example embodiment may provide a small-sized dust collection device.

A motor assembly according to an example embodiment may provide a small-sized motor assembly.

A vacuum cleaner according to an example embodiment may provide a vacuum cleaner having strong suction force.

A dust collection device according to an example embodiment may provide a dust collection device having strong suction force.

A motor assembly according to an example embodiment may provide a motor assembly having strong suction force.

A motor assembly according to an example embodiment may provide a motor assembly having strong output.

A vacuum cleaner according to an example embodiment may provide a vacuum cleaner with reduced noise.

A dust collection device according to an example embodiment may provide a dust collection device with reduced noise.

A motor assembly according to an example embodiment may provide a motor assembly with reduced noise.

A second guide according to an example embodiment may reduce noise of a motor assembly.

A flow cohesive portion according to an example embodiment may reduce noise of a motor assembly.

A flow cohesive portion according to an example embodiment may prevent noise of a motor assembly from spreading.

A flow cohesive portion according to an example embodiment may prevent noise of a motor assembly from widely spreading.

A filter support according to an example embodiment may reduce noise of a motor assembly.

A barrier according to an example embodiment may reduce noise of a motor assembly.

A barrier according to an example embodiment may prevent noise of a motor assembly from being directed to a discharge portion.

A barrier according to an example embodiment may prevent noise of a motor assembly from being directly discharged.

A motor assembly according to an example embodiment may provide a motor assembly with improved cooling performance of a control board.

A motor assembly according to an example embodiment may provide a motor assembly that prevents overheating of a control board.

A second guide according to an example embodiment may prevent overheating of a control board.

A flow cohesive portion according to an example embodiment may prevent overheating of a control board.

A flow cohesive portion according to an example embodiment may increase the heat exchange efficiency between air sucked in by the motor assembly and the control board.

A flow cohesive portion according to an example embodiment may condense air sucked in by a motor assembly.

A flow cohesive portion according to an example embodiment may condense air sucked in by a motor assembly and then transfer the air to a control board.

A second guide according to an example embodiment may have a structure to be coupled to a fan motor.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A motor assembly configured to generate suction force in a vacuum cleaner, the motor assembly comprising:
a control board;
a fan motor;
an impeller that is rotated by the fan motor;
a first guide that covers the impeller and guides sucked-in air in an axial direction of the impeller along an air flow path to be directed to the control board; and
a second guide disposed between the first guide and the control board to cover the fan motor and guide air along the air flow path,
wherein the second guide is located apart from the control board, and
wherein the second guide comprises a nozzle portion having a gradient of a certain angle with respect to the axial direction at an end facing the control board.

2. The motor assembly of claim 1, wherein the gradient of the certain angle with respect to the axial direction of the nozzle portion is 5° to 60°.

3. The motor assembly of claim 2, wherein a length of the nozzle portion is 2 millimeters (mm) or more.

4. The motor assembly of claim 1, wherein a thickness of the second guide is 1 millimeter (mm) or more and 3 mm or less.

5. The motor assembly of claim 1, wherein an interval between the second guide and the control board is 5 millimeters (mm) or more.

6. The motor assembly of claim 1,
wherein the second guide comprises a clip portion and a link, and
wherein the clip portion is configured to fasten two side ends of the second guide as the link is curved.

7. The motor assembly of claim 1, further comprising:
a guide cover surrounding the first guide,
wherein the guide cover comprises an elastic material.

8. The motor assembly of claim 7, wherein the guide cover seals a space between the first guide and the second guide.

9. The motor assembly of claim 1, further comprising:
a support frame covering the second guide,
wherein the support frame comprises a plurality of discharge holes arranged along an outer circumferential surface.

10. The motor assembly of claim 9, further comprising:
a housing comprising a suction portion in the axial direction and a discharge portion in a radial direction that intersects with the axial direction,
wherein the housing constitutes an outer appearance of the motor assembly.

11. The motor assembly of claim 10, further comprising:
a filter disposed between the support frame and the housing,
wherein the filter is configured to collect foreign substances discharged to the discharge portion.

12. The motor assembly of claim 11, further comprising:
a filter support disposed between the filter and the support frame,
wherein the filter support is configured to support the filter, and
wherein the filter support comprises a barrier that covers, from an outside, a discharge hole that is from among the plurality of discharge holes and located to face the discharge portion.

13. The motor assembly of claim 12, wherein an interval between the barrier and the discharge hole is 4 millimeters (mm) or more and 6 mm or less.

14. A dust collection device configured to generate suction force in a vacuum cleaner and temporarily store foreign substances sucked in by the vacuum cleaner, the dust collection device comprising:
a motor portion comprising a motor assembly; and
a dust collector configured to separate foreign substances from air sucked in by the vacuum cleaner and temporarily store the foreign substances,
wherein the motor assembly comprises:
a control board,
a fan motor,
an impeller that is rotated by the fan motor,
a first guide that covers the impeller and guides sucked-in air in an axial direction of the impeller along an air flow path to be directed to the control board, and
a second guide disposed between the first guide and the control board to cover the fan motor and guide air along the air flow path,
wherein the second guide is located apart from the control board, and
wherein the second guide comprises a nozzle portion having a gradient of a certain angle with respect to the axial direction at an end facing the control board.

15. A vacuum cleaner comprising:
a suction device configured to suck in foreign substances;
a vacuum cleaner body comprising a dust collection device configured to store the foreign substances sucked in through the suction device; and
a transfer portion disposed between the suction device and the vacuum cleaner body and configured to transfer sucked-in foreign substances from the suction device to the vacuum cleaner body,
wherein the dust collection device comprises:
a motor portion comprising a motor assembly, and
a dust collector configured to separate foreign substances from air sucked in by the vacuum cleaner and temporarily store the foreign substances, wherein the motor assembly comprises:
a control board,
a fan motor,
an impeller that is rotated by the fan motor,
a first guide that covers the impeller and guides sucked-in air in an axial direction of the impeller along an air flow path to be directed to the control board, and
a second guide disposed between the first guide and the control board to cover the fan motor and guide air along the air flow path,
wherein the second guide is located apart from the control board, and
wherein the second guide comprises a nozzle portion having a gradient of a certain angle with respect to the axial direction at an end facing the control board.

16. The vacuum cleaner of claim 15, wherein the gradient of the certain angle with respect to the axial direction of the nozzle portion is 5° to 60°.

17. The vacuum cleaner of claim 16, wherein a length of the nozzle portion is 2 millimeters (mm) or more.

18. The vacuum cleaner of claim 15, wherein a thickness of the second guide is 1 millimeter (mm) or more and 3 mm or less.

19. The vacuum cleaner of claim 15, wherein an interval between the second guide and the control board is 5 millimeters (mm) or more.

20. The vacuum cleaner of claim 15,
wherein the second guide comprises a clip portion and a link, and
wherein the clip portion is configured to fasten two side ends of the second guide as the link is curved.
